(19) United States
(12) Patent Application Publication
(10) Pub. No.: US 2014/0192330 A1
(43) Pub. Date: Jul. 10, 2014

(54) ILLUMINATION DEVICE AND PROJECTOR

(71) Applicant: Seiko Epson Corporation, Tokyo (JP)

(72) Inventor: Yasutaka Imai, Suwa (JP)

(73) Assignee: Seiko Epson Corporation, Tokyo (JP)

(21) Appl. No.: 14/149,048

(22) Filed: Jan. 7, 2014

(30) Foreign Application Priority Data
Jan. 7, 2013 (JP) 2013-000351

(51) Int. Cl. H04N 9/31; H05B 37/02; F21V 5/04

(52) U.S. Cl. CPC H04N 9/3164; F21V 5/04; H05B 37/02
USPC 353/30; 362/311.01; 315/150

(57) ABSTRACT

An illumination device includes: a light emitting element that includes an active layer, a first clad layer and a second clad layer with the active layer interposed therebetween, and a first gain region and a second gain region generating light when a current flows through the active layer; a control unit that operates the light emitting element so that light is alternately generated in the first gain region and the second gain region; and a first lens to which light emitted from a first light emitting portion of the first gain region and light emitted from a second light emitting portion of the second gain region are incident, wherein the light emitted from the first light emitting portion and the light emitted from the second light emitting portion are emitted in the same direction and are incident to the first lens.

### BACKGROUND

1. Technical Field

The present invention relates to an illumination device and a projector.

2. Related Art

In recent years, a technique has been proposed in which a semiconductor light emitting element such as a super luminescent diode (hereinafter, referred to as an “SLD”) or a laser is used as an illumination device (a light source module) of a projector. The projector is required to have high luminance, and a semiconductor light emitting element including a plurality of light emitting portions which emit light is used as one of means for obtaining a high output level of an illumination device.

For example, JP-A-2011-3686 discloses a technique in which light emitting portions adjacent to each other are made to alternately emit light, so as to prevent or reduce thermal interference between gain regions adjacent to each other.

However, in a light emitting apparatus disclosed in JP-A-2011-3686, for example, a lens which adjusts a radiation angle distribution is disposed in a single light emitting portion, thereby forming an illumination device. For this reason, in the light emitting apparatus disclosed in JP-A-2011-3686, when light is alternately emitted from the light emitting portions adjacent to each other, uniformity of an intensity distribution of illumination light emitted from the illumination device may deteriorate.

### SUMMARY

An advantage of some aspects of the invention is to provide an illumination device capable of emitting illumination light with favorable uniformity in an intensity distribution. In addition, another advantage of some aspects of the invention is to provide a projector including the illumination device.

An aspect of the invention is directed to an illumination device including a light emitting element that includes an active layer, a first clad layer and a second clad layer with the active layer interposed therebetween, and a first gain region and a second gain region generating light when a current flows through the active layer; a control unit that operates the light emitting element so that light is alternately generated in the first gain region and the second gain region; and a first lens to which light emitted from a first light emitting portion of the first gain region and light emitted from a second light emitting portion of the second gain region are incident, in which the light emitted from the first light emitting portion and the light emitted from the second light emitting portion are emitted in the same direction and are incident to the first lens.

According to the illumination device, it is possible to emit illumination light with favorable uniformity in an intensity distribution.

The illumination device according to the aspect of the invention may be configured such that the first light emitting portion and the second light emitting portion are provided on a first lateral surface of the active layer; the first gain region connects the first light emitting portion to a third light emitting portion provided on the first lateral surface of the active layer; the second gain region connects the second light emitting portion to a fourth light emitting portion provided on the first lateral surface of the active layer; and light emitted from the first light emitting portion, light emitted from the second light emitting portion, light emitted from the third light emitting portion, and light emitted from the fourth light emitting portion are emitted in the same direction.

According to the illumination device of this configuration, respective light beams which are generated in the first gain region and the second gain region and are emitted from two end portions can be emitted from a single lateral surface.

The illumination device according to the aspect of the invention may be configured such that the illumination device further includes a second lens to which the light emitted from the third light emitting portion is incident.

According to the illumination device of this configuration, it is possible to emit illumination light with favorable uniformity in an intensity distribution.

The illumination device according to the aspect of the invention may be configured such that the illumination device further includes a light detection portion to which light emitted from the fourth light emitting portion is incident, and the control unit operates the light emitting element on the basis of light detected by the light detection portion.

According to the illumination device of this configuration, it is possible to maintain alight output level to be more stable.

The illumination device according to the aspect of the invention may be configured such that the first gain region and the second gain region have a U shape when viewed from a direction in which the first clad layer, the active layer, and the second clad layer are laminated.

According to the illumination device of this configuration, it is possible to emit illumination light with favorable uniformity in an intensity distribution.

The illumination device according to the aspect of the invention may be configured such that the control unit operates the light emitting element so that an emission time of the first gain region and an emission time of the second gain region are the same as each other.

According to the illumination device of this configuration, it is possible to emit illumination light with favorable uniformity in an intensity distribution.

The illumination device according to the aspect of the invention may be configured such that the control unit operates the light emitting element so that an emission time of the first gain region and an emission time of the second gain region are different from each other.

According to the illumination device of this configuration, it is possible to reduce speckle noise (details thereof will be described later).

The illumination device according to the aspect of the invention may be configured such that the light emitting element is a super luminescent diode.

According to the illumination device of this configuration, it is possible to reduce speckle noise by suppressing a resonator from being formed due to edge reflection.

Another aspect of the invention is directed to a projector including the illumination device according to the aspect of the invention; a spatial light modulation device that modulates light emitted from the illumination device according to image information; and a projection device that projects an image formed by the spatial light modulation device.

The projector includes the illumination device according to the aspect of the invention, and thus can reduce uneven luminance.

Still another aspect of the invention is directed to a projector including a light emitting element that includes an active layer, a first clad layer and a second clad layer with the active layer interposed therebetween, and a first gain region and a second gain region generating light when a current flows through the active layer; a control unit that operates the light emitting element so that light is alternately generated in the first gain region and the second gain region; a first lens to which light emitted from a first light emitting portion of the first gain region and light emitted from a second light emitting portion of the second gain region are incident; a spatial light modulation device that modulates light emitted from the first lens according to image information; and a projection device that projects an image formed by the spatial light modulation device.

The projector includes the illumination device according to the aspect of the invention, and thus can reduce uneven luminance.

### BRIEF DESCRIPTION OF THE DRAWINGS

The invention will be described with reference to the accompanying drawings, wherein like numbers reference like elements.

FIG. 1 is a plan view schematically illustrating an illumination device according to a first embodiment.

FIG. 2 is a plan view schematically illustrating the illumination device according to the first embodiment.

FIG. 3 is a cross-sectional view schematically illustrating the illumination device according to the first embodiment.

FIG. 4 is a cross-sectional view schematically illustrating the illumination device according to the first embodiment.

FIGS. 5A to 5C are diagrams illustrating an operation of the illumination device according to the first embodiment.

FIG. 6 is a diagram illustrating a relationship between a current and a light output level.

FIG. 7 is a cross-sectional view schematically illustrating a manufacturing step of the illumination device according to the first embodiment.

FIG. 8 is a cross-sectional view schematically illustrating a manufacturing step of the illumination device according to the first embodiment.

FIGS. 9A to 9C are diagrams illustrating an operation of an illumination device according to Modification Example 1 of the first embodiment.

FIG. 10 is a diagram illustrating a relationship between a current and a light output level.

FIGS. 11A to 11C are diagrams illustrating a relationship between a wavelength and a light output level, of light emitted from the illumination device according to Modification Example 1 of the first embodiment.

FIG. 12 is a plan view schematically illustrating an illumination device according to Modification Example 2 of the first embodiment.

FIG. 13 is a cross-sectional view schematically illustrating the illumination device according to Modification Example 2 of the first embodiment.

FIG. 14 is a plan view schematically illustrating an illumination device according to a second embodiment.

FIG. 15 is a plan view schematically illustrating the illumination device according to the second embodiment.

FIG. 16 is a cross-sectional view schematically illustrating the illumination device according to the second embodiment.

FIG. 17 is a plan view schematically illustrating an illumination device according to Modification Example 1 of the second embodiment.

FIG. 18 is a plan view schematically illustrating an illumination device according to Modification Example 2 of the second embodiment.

FIG. 19 is a plan view schematically illustrating the illumination device according to Modification Example 2 of the second embodiment.

FIG. 20 is a plan view schematically illustrating an illumination device according to Modification Example 3 of the second embodiment.

FIG. 21 is a diagram schematically illustrating a projector according to a third embodiment.

### DESCRIPTION OF EXEMPLARY EMBODIMENTS

Hereinafter, preferred embodiments of the invention will be described in detail with reference to the drawings. In addition, the embodiments described below do not unjustly limit the content of the invention recited in the appended claims. Further, it cannot be said that all constituent elements described below are indispensable constituent elements of the invention.

### 1. First Embodiment

### 1.1 Illumination Device

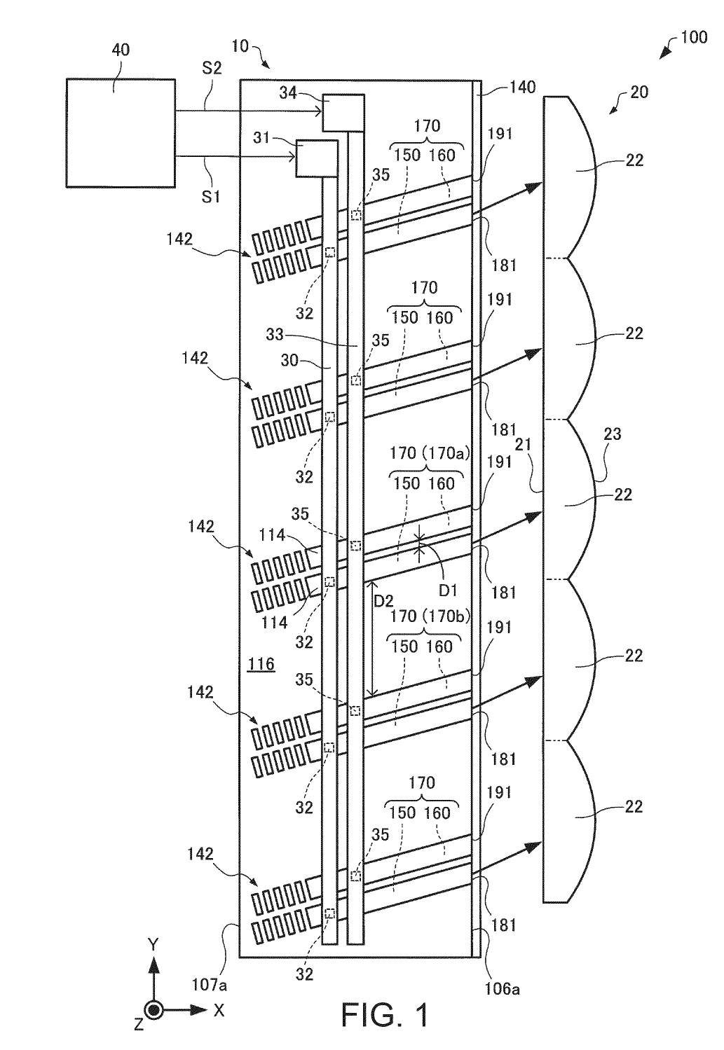

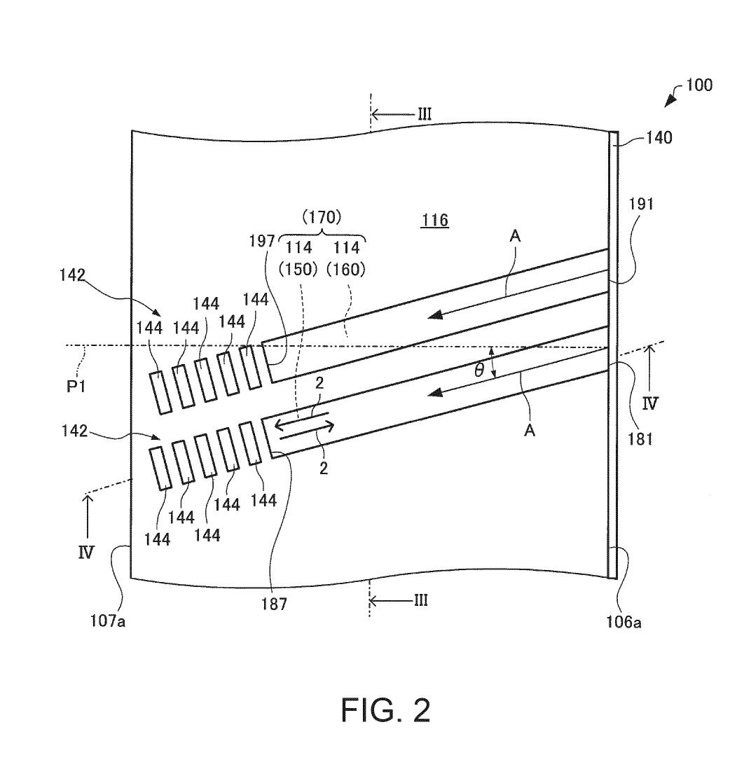

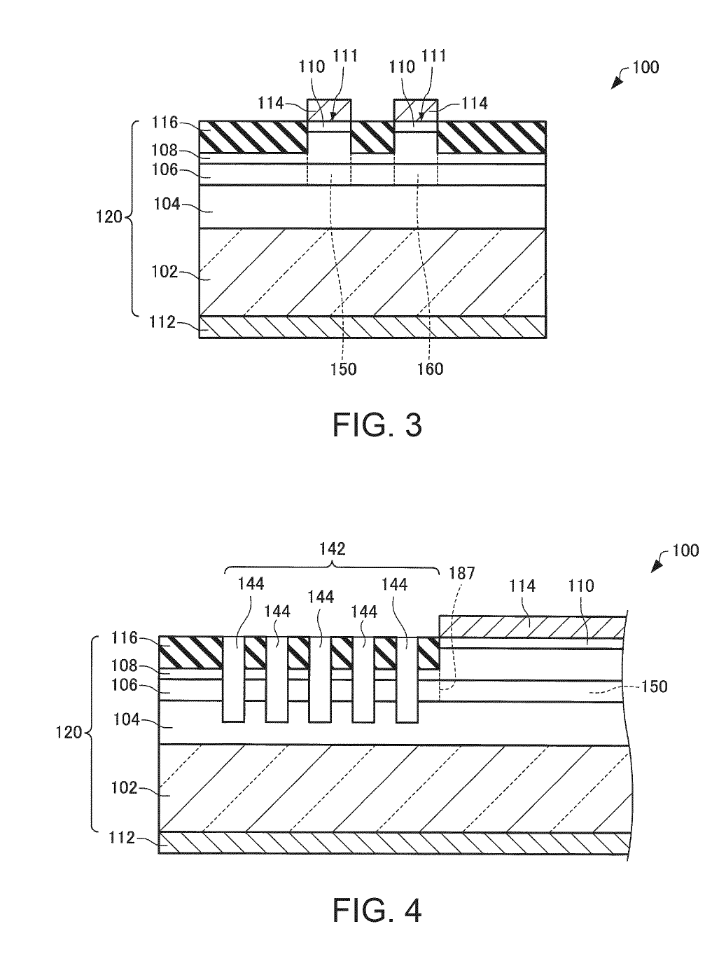

First, an illumination device according to a first embodiment will be described with reference to the drawings. FIG. 1 is a plan view schematically illustrating an illumination device 100 according to the first embodiment. FIG. 2 is a plan view schematically illustrating the illumination device 100 according to the first embodiment, and is an enlarged view of FIG. 1. FIG. 3 is a diagram schematically illustrating the illumination device 100 according to the first embodiment, and is a cross-sectional view taken along the line of FIG. 2. FIG. 4 is a diagram schematically illustrating the illumination device 100 according to the first embodiment, and is a cross-sectional view taken along the line IV-IV of FIG. 2. In addition, for convenience of description, wires 30 and 33 and contact portions 32 and 35 are not illustrated in FIGS. 2 to 4. Further, FIG. 1 illustrates an X axis, a Y axis, and a Z axis as three axes perpendicular to each other.

The illumination device 100 includes, as illustrated in FIGS. 1 to 4, a light emitting element 10, first lenses 22, and a control unit 40.

Hereinafter, a description will be made of a case where the light emitting element 10 is an InGaAlP-based (red) SLD. The SLD can prevent laser oscillation by suppressing a resonator from being formed due to edge reflection unlike a semiconductor laser. For this reason, speckle noise can be reduced.

As illustrated in FIGS. 1 to 4, the light emitting element 10 may include a laminate 120, a first electrode 112, second electrodes 114, an antireflection film 140, a reflective portion 142, wires 30 and 33, pads 31 and 34, and contact portions 32 and 35. The laminate 120 may include a substrate 102, a first clad layer 104, an active layer 106, a second clad layer 108, a contact layer 110, and an insulating layer 116.

As the substrate 102, for example, a first conductivity type (for example, an n type) GaAs substrate or the like may be used.

The first clad layer 104 is formed on the substrate 102. As the first clad layer 104, a first conductivity type (for example, an n type) InGaAlP layer or the like may be used. In addition, although not illustrated, a buffer layer may be formed between the substrate 102 and the first clad layer 104. As the buffer layer, for example, a first conductivity type (for example, an n type) GaAs layer, AlGaAs layer, InGaP layer, or the like may be used. The buffer layer can improve crystallinity of a layer formed thereon.

The active layer 106 is formed on the first clad layer 104. The active layer 106 is interposed between the first clad layer 104 and the second clad layer 108. The active layer 106 has, for example, a multiple quantum well (MQW) structure in which three quantum well structures each of which includes an InGaP well layer and an InGaAlP barrier layer overlap each other.

A part of the active layer 106 forms a first gain region 150 and a second gain region 160. The gain regions 150 and 160 can generate light when a current flows therethrough, and this light can be guided through the gain regions 150 and 160 while receiving a gain.

In the example illustrated in FIG. 1, each of the gain regions 150 and 160 is provided in plurality. The gain regions 150 and 160 are alternately provided along the Y axis. More specifically, the gain regions 150 and 160 form a pair of gain regions 170, and a plurality of pairs of gain regions 170 are provided along the Y axis at equal intervals. A gap D1 between the gain regions 150 and 160 forming a pair of gain regions 170a is smaller than a gap D2 between the gain region 150 forming the pair of gain regions 170a and the gain region 160 forming a pair of gain regions 170b adjacent to the pair of gain regions 170a.

A shape of the active layer 106 is, for example, a cuboid shape (including a case of a cube shape) or the like. The active layer 106 has a lateral surface (a first lateral surface) 106a and a lateral surface (a second lateral surface) 107a. The lateral surface 106a and the lateral surface 107a are parallel to each other, for example.

The first gain region 150 has an end surface 181 on the lateral surface 106a side and an end surface 187 on the lateral surface 107a side as illustrated in FIG. 2. The second gain region 160 has an end surface 191 on the lateral surface 106a side and an end surface 197 on the lateral surface 107a side. The end surfaces 181 and 191 are provided on the lateral surface 106a. The end surfaces 187 and 197 do not reach the lateral surface 107a, and the second end surfaces 187 and 197 are not provided on the lateral surface 107a.

A reflectance of the end surface 187 is higher than a reflectance of the end surface 181 in a wavelength band of light which is generated in the first gain region 150. A reflectance of the end surface 197 is higher than a reflectance of the end surface 191 in a wavelength band of light which is generated in the second gain region 160. The reflectances of the end surfaces 187 and 197 are preferably 100% or are close thereto. In contrast, the reflectances of the end surfaces 181 and 191 are preferably 0% or are close thereto. For example, the antireflection film 140 is provided on the end surfaces 181 and 191, and thus a low reflectance can be obtained. Accordingly, light which is generated in the gain regions 150 and 160 can be emitted from the end surfaces 181 and 191. In other words, the end surface 181 is a first light emitting portion which emits light generated in the first gain region 150, and the end surface 191 is a second light emitting portion which emits light generated in the second gain region 160. In the illustrated example, the antireflection film 140 is provided on the entire lateral surface 106a. As the antireflection film 140, for example, an Al₂O₃ single layer, a SiO₂ layer, a SiN layer, a Ta₂O₅ layer, a multilayer film thereof, or the like may be used.

The end surfaces 187 and 197 are provided with the reflective portion 142, which will be described later, and thus can have a high reflectance. The end surfaces 187 and 197 are provided so as to be perpendicular to the direction (extension direction) A in which the gain regions 150 and 160 extend as illustrated in FIG. 2. Accordingly, light generated in the gain regions 150 and 160 can be efficiently reflected in the reflective portion 142 provided on the end surfaces 187 and 197.

The first gain region 150 extends in a tilt direction with respect to a perpendicular line P1 of the first lateral surface 106a from the end surface 181 to the end surface 187 when viewed from the laminate direction of the laminate 120 (when viewed from the laminate direction of the first clad layer 104, the active layer 106, and the second clad layer 108 (hereinafter, simply referred to as “in a plan view”)). The second gain region 160 extends in a tilt direction with respect to the perpendicular line P1 from the end surface 191 to the end surface 197 in a plan view. In the illustrated example, the gain regions 150 and 160 extend in the tilt direction A with an angle θ with respect to the perpendicular line P1. Therefore, it is possible to suppress or prevent laser oscillation of light generated in the gain regions 150 and 160. In addition, the extension direction A of the first gain region 150 refers to, for example, a direction which connects a center of the end surface 181 to a center of the end surface 187 in a plan view. This is also the same for the second gain region 160.

The extension direction of the first gain region 150 and the extension direction of the second gain region 160 are parallel to each other. Accordingly, in the illumination device 100, light emitted from the end surface (the first light emitting portion) 181 of the first gain region 150 and light emitted from the end surface (the second light emitting portion) 191 of the second gain region 160 can be emitted in the same direction and be incident to the first lens 22.

The reflective portion 142 is provided on the end surfaces 187 and 197 of the gain regions 150 and 160. The reflective portion 142 is, for example, a distributed Bragg reflector (DBR) mirror (hereinafter, also referred to as a “DBR mirror”). In the illustrated example, the reflective portion 142 includes a plurality of grooves 144 which are disposed at predetermined intervals. A planar shape (a shape viewed from the laminate direction of the laminate 120) of the groove 144 is a rectangular shape, for example. A set of sides (long sides in the example of FIG. 2) opposed to each other of the groove 144 are provided so as to be parallel to the end surfaces 187 and 197. In the example illustrated in FIG. 4, a position of the bottom surface of the groove 144 is located to be lower than a position of the lower surface of the active layer 106. The groove 144 may be hollow, or may be filled with an insulating material.

In addition, although not illustrated, the reflective portion 142 may be a DBR mirror formed of a dielectric multilayer film in which a high refractive index layer and a low refractive index layer are alternately laminated, or may be a metal mirror formed of a metal thin film.

The second clad layer 108 is formed on the active layer 106. The second clad layer 108 may use, for example, a second conductivity type (for example, a p type) InGaAlP layer or the like.

For example, a pin diode is formed by the p type second clad layer 108, the active layer 106 which is not doped with an impurity, and the n type first clad layer 104. Each of the first clad layer 104 and the second clad layer 108 has a greater band gap and a smaller refractive index than the active layer 106. The active layer 106 generates light when a current is made to flow therethrough by the first electrode 112 and the second electrode 114, and has a function to amplify and guide the light. The first clad layer 104 and the second clad layer 108 have a function to confine injection carriers (electrons and holes) and light (a function to suppress light leakage) with the active layer 106 interposed therebetween.

In the light emitting element 10, when a forward bias voltage of the pin diode is applied between the first electrode 112 and the second electrode 114, recombination of electrons and holes occurs in the gain regions 150 and 160 of the active layer 106. This recombination causes light to be emitted. Linked stimulated emission occurs with the generated light as the starting point, and an intensity of light is amplified in the gain regions 150 and 160.

For example, as illustrated in FIG. 2, some beams 2 of the light beams generated in the first gain region 150 are reflected at the reflective portion 142 provided on the end surface 187 so as to be emitted from the end surface 181, and a light intensity is amplified during that time. In addition, the light generated in the first gain region 150 may be directly emitted from the end surface 181. This is also the same for light generated in the second gain region 160.

The contact layer 110 is formed on the second clad layer 108. The contact layer 110 may be in ohmic contact with the second electrode 114. As the contact layer 110, for example, a p type GaAs layer or the like may be used.

The contact layer 110 and a part of the second clad layer 108 may form a columnar portion 111 as illustrated in FIG. 3. A planar shape of the columnar portion 111 is the same as a planar shape of each of the gain regions 150 and 160. For example, a current path between the electrodes 112 and 114 is determined by a planar shape of the columnar portion 111, and, as a result, planar shapes of the gain regions 150 and 160 are determined. In addition, although not illustrated, a lateral surface of the columnar portion 111 may be tilted.

The insulating layer 116 is formed on the second clad layer 108 and lateral sides of the columnar portion 111 (around the columnar portion 111 in a plan view). The insulating layer 116 may be contiguous to the lateral surfaces of the columnar portion 111. The upper surface of the insulating layer 116 is continuous to, for example, the upper surface of the contact layer 110. As the insulating layer 116, for example, a SiN layer, a SiO₂ layer, a SiON layer, an Al₂O₃ layer, a polyimide layer, or the like may be used. In a case where the material is used as the insulating layer 116, a current between the electrodes 112 and 114 can avoid the insulating layer 116 and can flow through the columnar portion 111 interposed between the insulating layers 116.

The insulating layer 116 may have a refractive index smaller than a refractive index of the active layer 106. In this case, an effective refractive index of a vertical section of a part forming the insulating layer 116 is smaller than an effective refractive index of a vertical section of apart which does not form the insulating layer 116, that is, a part where the columnar portion 111 is formed. Therefore, it is possible to efficiently confine light in the gain regions 150 and 160 in a planar direction. In addition, although not illustrated, the above-described material may not be embedded as the insulating layer 116. In this case, an air layer may function as the insulating layer 116.

The first electrode 112 is formed on an entire lower surface of the substrate 102. The first electrode 112 may be contiguous to a layer (the substrate 102 in the illustrated example) which is in ohmic contact with the first electrode 112. The first electrode 112 is electrically connected to the first clad layer 104 via the substrate 102. The first electrode 112 is one electrode driving the light emitting element 10. As the first electrode 112, an electrode may be used in which, for example, a Cr layer, an AuGe layer, an Ni layer, and an Au layer are laminated in this order from the substrate 102 side.

In addition, a second contact layer (not illustrated) may be provided between the first clad layer 104 and the substrate 102, and the second contact layer is exposed to an opposite side to the substrate 102 through dry etching or the like on the opposite side to the substrate 102, thereby providing the first electrode 112 on the second contact layer. Therefore, a one-sided electrode structure may be obtained. This form is considerably effective to a case where the substrate 102 has an insulation property.

The second electrode 114 is formed on the contact layer 110. The second electrode 114 is electrically connected to the second clad layer 108 via the contact layer 110. The second electrode 114 is the other electrode driving the light emitting element 10. As the second electrode 114, an electrode may be used in which, for example, a Cr layer, an AuZn layer, and an Au layer are laminated in this order from the contact layer 110 side.

The wires 30 and 33 are formed over the second electrode 114 and the insulating layer 116 as illustrated in FIG. 1. The wires 30 and 33 intersect the gain regions 150 and 160 and extend along the Y axis in a plan view from the laminate direction of the first clad layer 104 and the active layer 106. The wire 30 is electrically connected to the second electrode 114 over a plurality of first gain regions 150. More specifically, an insulating layer (not illustrated) is provided between the wire 30 and the second electrode 114, and the wire 30 is electrically connected to the second electrode 114 via the contact portion 32 which penetrates through the insulating layer. The wire 33 is electrically connected to the second electrode 114 over a plurality of second gain regions 160. More specifically, an insulating layer (not illustrated) is provided between the wire 33 and the second electrode 114, and the wire 33 is electrically connected to the second electrode 114 via the contact portion 35 which penetrates through the insulating layer.

The pads 31 and 34 are provided on the insulating layer 116. The pad 31 is connected to the wire 30. The pad 34 is connected to the wire 33. Materials of the wires 30 and 33, the contact portions 32 and 35, and the pads 31 and 34 are not particularly limited as long as the materials have an insulating property.

The first lens 22 is provided singly for a pair of gain regions 170. In other words, light beams emitted from the light emitting portions 181 and 191 of the gain regions 150 and 160 forming a pair of gain regions 170 are incident to a single first lens 22. In the example illustrated in FIG. 1, a plurality of first lenses 22 are provided so as to correspond to a plurality of pairs of gain regions 170. A plurality of first lenses 22 are provided along the Y axis so as to form a lens array 20. The first lens 22 has an incidence surface 21 to which light emitted from the light emitting portions 181 and 191 is incident and an emission surface 23 from which the incident light is emitted. The incidence surface 21 is, for example, a flat surface. The emission surface 23 is, for example, a convex surface which has a rotational symmetric shape with respect to a predetermined axis.

A material of the lens array 20 is, for example, glass. For example, the first lens 22 can control (collimate, condense, and the like) a radiation angle of light incident to the first lens 22 so that light incident to the first lens 22 can be emitted from the first lens 22, for example, as parallel light.

The control unit 40 operates the light emitting element 10 so that the first gain region 150 and the second gain region 160 alternately generate light. Accordingly, the light emitting element 10 can alternately emit light from the first light emitting portion 181 and the second light emitting portion 191. In addition, the light emitted from the first light emitting portion 181 and the light emitted from the second light emitting portion 191 can be alternately incident to the first lens 22. The control unit 40 is, for example, an integrated circuit. Further, in the example illustrated in FIG. 1, a case where light is emitted from the first light emitting portion 181 is illustrated.

More specifically, the control unit 40 supplies a driving signal S1 to the pad 31 so as to generate light in the first gain region 150 as illustrated in FIG. 1. In addition, the control unit 40 supplies a driving signal S2 to the pad 34 so as to generate light in the second gain region 160.

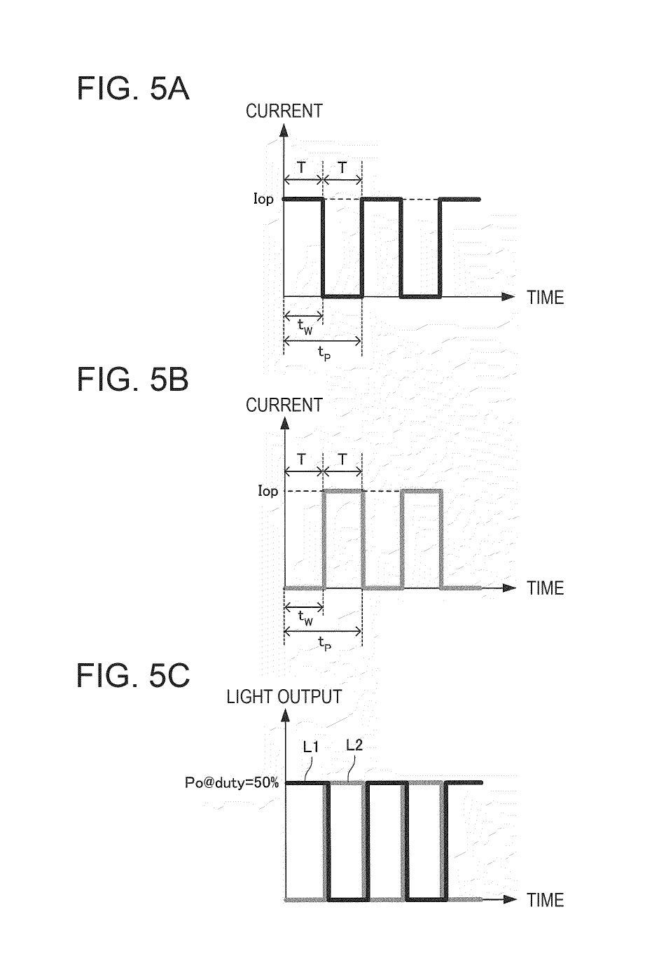

Here, FIGS. 5A to 5C are diagrams illustrating an operation of the illumination device 100 according to the first embodiment. More specifically, FIG. 5A is a diagram illustrating the driving signal S1 for generating light in the first gain region 150. FIG. 5B is a diagram illustrating the driving signal S2 for generating light in the second gain region 160.

As illustrated in FIGS. 5A and 5B, the control unit 40 stops the supply of an operation current Iop to the second gain region 160 (the pad 34) while supplying the operation current Iop to the first gain region 150 (the pad 31). In addition, the control unit 40 stops the supply of the operation current Iop to the first gain region 150 and starts again the supply of the operation current Iop to the second gain region 160 when a predetermined time T has elapsed after the operation current Iop starts to be supplied to the first gain region 150. The control unit 40 stops the supply of the operation current Iop to the first gain region 150 while supplying the operation current Iop to the second gain region 160. Further, the control unit 40 stops the supply of the operation current Iop to the second gain region 160 and starts the supply of the operation current Iop to the first gain region 150 when the predetermined time T has elapsed after the operation current Iop starts to be supplied to the second gain region 160. The control unit 40 repeatedly performs this operation. In other words, the control unit 40 supplies pulse currents as illustrated in FIGS. 5A and 5B to the light emitting element 10 as the driving signals S1 and S2.

In the example illustrated in FIG. 5A, a pulse width t_{w} of the pulse current is T, and a cycle tₚ thereof is 2T. Therefore, a duty ratio (t_{w}/tₚ×100) is 50%. This is also the same for the example illustrated in FIG. 5B, and a duty ratio is 50%. In other words, the control unit 40 operates the light emitting element 10 so that an emission time of the first gain region 150 and an emission time of the second gain region 160 are the same as each other. The predetermined time T is, for example, several μs. It can be said that the pulse current supplied to the first gain region 150 and the pulse current supplied to the second gain region 160 have phases opposite to each other.

FIG. 5C is a diagram illustrating a light output level (of the pair of gain regions 170) of the light emitting element 10 when the light emitting element 10 is pulse-driven using the pulse currents illustrated in FIGS. 5A and 5B.

As described above, the control unit 40 supplies pulse currents with a duty ratio of 50% to the gain regions 150 and 160. For this reason, as illustrated in FIG. 5C, a light output level L1 when the operation current Iop is supplied to the first gain region 150 is the same as a light output level L2 when the operation current Iop is supplied to the second gain region 160 (in the illustrated example, Po@duty=50%).

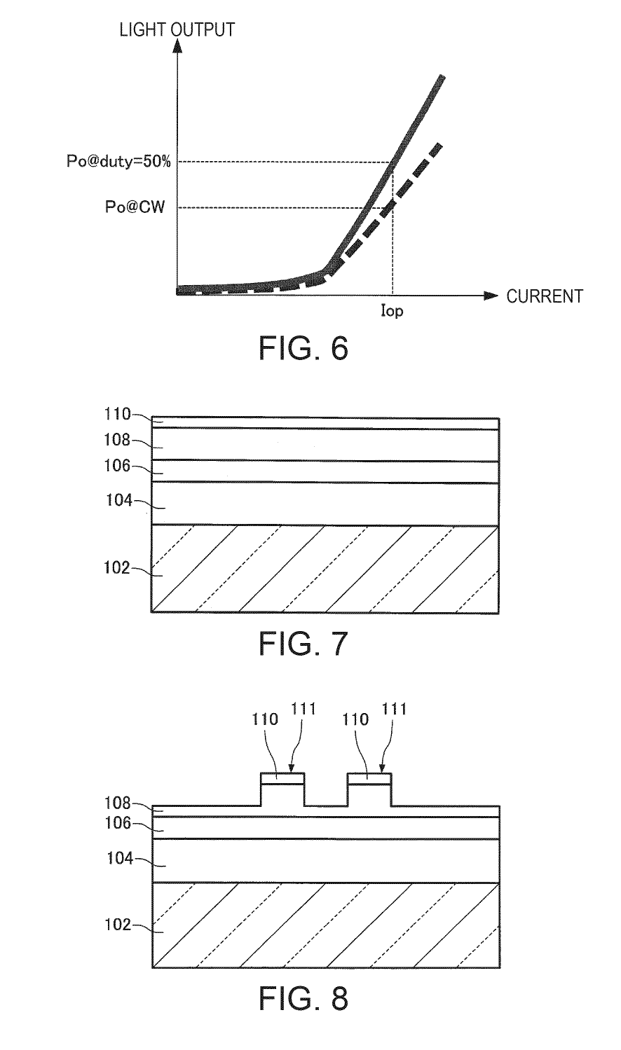

Here, FIG. 6 is a diagram illustrating a relationship between a current and a light output level when a single gain region is pulse-driven at the duty ratio of 50% and a relationship between a current and a light output level when the single gain region is continuously driven (CW-driven).

As illustrated in FIG. 6, when the operation current Iop is supplied to the gain region, a light output level (Po@duty=50%) when pulse driving is performed at the duty ratio of 50% is greater than a light output level (Po@CW) when continuous driving is performed. In other words, the pulse driving further improves slope efficiency. This is because efficiency reduction due to self heat generation is smaller in the pulse driving than in the CW driving.

In the illumination device 100, since the operation current Iop is alternately supplied to the first gain region 150 and the second gain region 160, it is possible to obtain a higher output level than in a case where the operation current Iop is supplied to a single gain region through the CW driving.

In addition, in the above description, although the InGaAlP-based material has been described as an example of the light emitting element 10 of the illumination device 100, the light emitting element 10 may use any material which can form an emission gain region. As for a semiconductor material, semiconductor materials such as, for example, AlGaN-based, GaN-based, InGaN-based, GaAs-based, AlGaAs-based, InGaAs-based, InGaAsP-based, and ZnCdSe-based materials, may be used.

In the above description, as an example of the light emitting element 10, a description has been made of the refractive index waveguide type element in which there is a refractive index difference between the region where the insulating layer 116 is formed and the region where the insulating layer 116 is not formed, that is, the region forming the columnar portion 111, so as to confine light. In contrast, the light emitting element 10 may be a gain waveguide type element in which there is no refractive index difference by forming a columnar portion, and a gain region is a waveguide region as it is. However, a refractive index waveguide type is preferably used in consideration of light coupling between gain regions and a waveguide loss of coupled light.

In the above description, although a description has been made of a form in which the gain regions 150 and 160 linearly extend as an example of the light emitting element 10, a light emitting element according to an aspect of the invention is not particularly limited as long as the light emitting element has two light emitting portions on a single lateral surface. For example, a light emitting element according to an aspect of the invention may have a form in which two light emitting portions on a single lateral surface are connected to each other via a gain region having a curvature.

The illumination device 100 according to the first embodiment has the following features, for example.

According to the illumination device 100, the control unit 40 operates the light emitting element 10 so that light is alternately generated in the first gain region 150 and the second gain region 160, and light emitted from the first light emitting portion 181 of the first gain region 150 and light emitted from the second light emitting portion 191 of the second gain region 160 are incident to a single first lens 22. For this reason, the illumination device 100 can emit light with a high output level and favorable uniformity as compared with a form in which a single lens is disposed for each light emitting portion, and alternative driving is performed on every other light emitting portion (a case where an electrode is common in every other light emitting portion and alternative emission is performed). In other words, light with favorable uniformity can be emitted from the lens array 20. For example, in a form in which a single lens is disposed for each light emitting portion, and alternative driving is performed on every other light emitting portion, there is a case where light is not simultaneously emitted from lenses adjacent to each other, and thus emission density of an illumination device is reduced and uniformity of light emitted from the illumination device deteriorates.

In addition, in the illumination device 100, as described above, since the operation current lop is alternately supplied to the first gain region 150 and the second gain region 160, it is possible to obtain a high output level as compared with a case where the operation current Iop is supplied to a single gain region through CW driving.

### 1.2 Manufacturing Method of Illumination Device

Next, a manufacturing method of the illumination device according to the first embodiment will be described with reference to the drawings. FIGS. 7 and 8 are cross-sectional views schematically illustrating manufacturing steps of the illumination device 100 according to the first embodiment, and are diagrams corresponding to FIG. 3.

As illustrated in FIG. 7, the first clad layer 104, the active layer 106, the second clad layer 108, and the contact layer 110 are epitaxially grown in this order on the substrate 102. As a method for epitaxial growth, for example, a metal organic chemical vapor deposition (MOCVD) method, a molecular beam epitaxy (MBE) method, or the like may be used.

As illustrated in FIG. 8, the contact layer 110 and the second clad layer 108 are patterned. The columnar portion 111 can be formed due to this step. The patterning is performed using, for example, a photolithography technique and an etching technique.

As illustrated in FIG. 3, the insulating layer 116 is formed so as to cover the lateral surfaces of the columnar portion 111. Specifically, first, an insulating member (not illustrated) is formed on the second clad layer 108 (including the upper side of the contact layer 110) by using, for example, a chemical vapor deposition (CVD) method, a coating method, or the like. Next, the upper surface of the contact layer 110 is exposed using, for example, an etching technique. Due to the above steps, the insulating layer 116 can be formed.

As illustrated in FIG. 4, the grooves 144 forming the reflective portion 142 are formed. The grooves 144 are formed by patterning the insulating layer 116, the second clad layer 108, the active layer 106, and the first clad layer 104. The patterning is performed using, for example, a photolithography technique and an etching technique.

As illustrated in FIGS. 3 and 4, the second electrode 114 is formed on the contact layer 110. Next, the first electrode 112 is formed on the lower surface of the substrate 102. The first electrode 112 and the second electrode 114 are formed using, for example, a vapor deposition method. In addition, an order in which the first electrode 112 and the second electrode 114 are formed is not particularly limited.

As illustrated in FIG. 1, the antireflection film 140 is formed so as to cover the lateral surface 106a. The antireflection film 140 is formed using, for example, a CVD method. In addition, the step of forming the antireflection film 140 may be performed before the step of forming the electrodes 112 and 114, or may be performed before the step of forming the grooves 144.

Due to the above steps, the illumination device 100 according to the first embodiment can be manufactured.

### 1.3 Modification Examples of Illumination Device

### 1. Modification Example 1

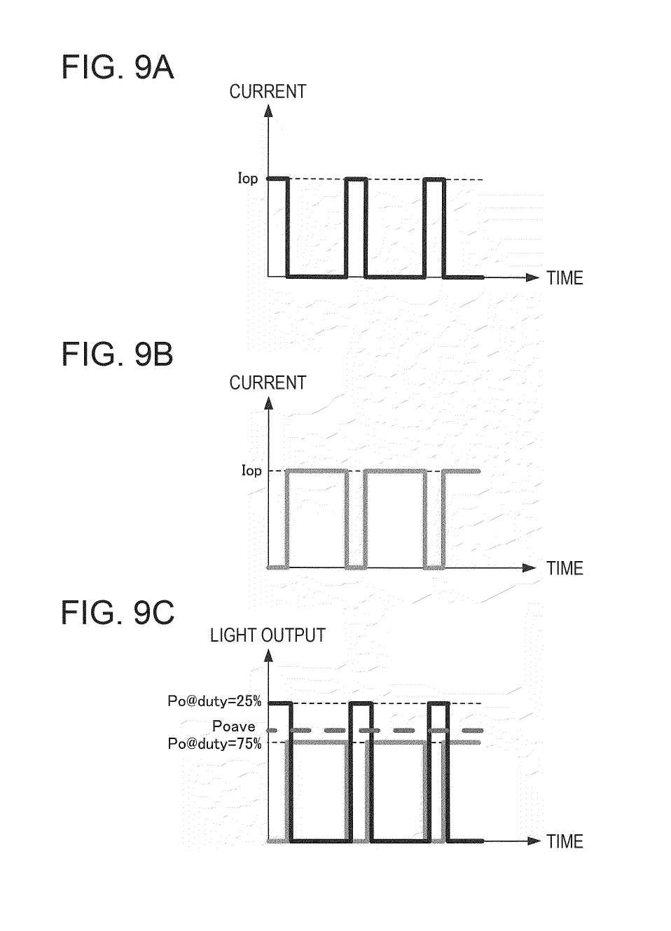

Next, with reference to the drawings, a description will be made of an illumination device according to Modification Example 1 of the first embodiment. FIGS. 9A to 9C are diagrams illustrating an operation of the illumination device according to Modification Example 1 of the first embodiment. More specifically, FIG. 9A is a diagram illustrating a driving signal S1 for generating light in the first gain region 150. FIG. 9B is a diagram illustrating a driving signal S2 for generating light in the second gain region 160. FIG. 9C is a diagram illustrating a light output level when the light emitting element 10 is pulse-driven using the pulse currents illustrated in FIGS. 9A and 9B.

Hereinafter, in the illumination device according to Modification Example 1 of the first embodiment, differences from the illumination device 100 according to the first embodiment will be described, and description of similarities thereto will be omitted.

In the illumination device 100, as illustrated in FIGS. 5A and 5B, the control unit 40 supplies the pulse currents with the duty ratio of 50% to the gain regions 150 and 160.

In contrast, in the illumination device according to Modification Example 1, as illustrated in FIGS. 9A and 9B, a pulse current with a duty ratio of 25% is supplied to the first gain region 150, and a pulse current with a duty ratio of 75% is supplied to the second gain region 160. In other words, the control unit 40 operates the light emitting element 10 so that an emission time of the first gain region 150 and an emission time of the second gain region 160 are different from each other.

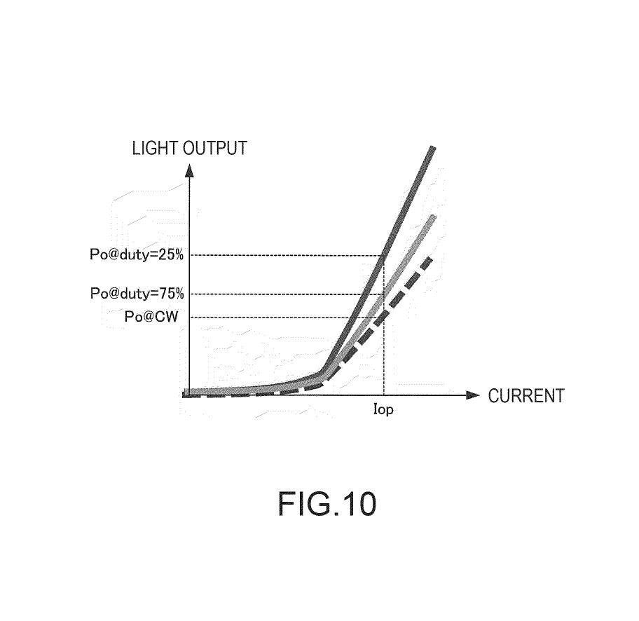

As illustrated in FIG. 9C, a light output level (Po@duty=25%) when the operation current Iop is supplied to the first gain region 150 is greater than a light output level (Po@duty=75%) when the operation current Iop is supplied to the second gain region 160. This is because, as illustrated in FIG. 10, influence of self heat generation is smaller and slope efficiency is further improved in a case of the supply of the pulse current with the duty ratio of 25% than in a case of the supply of the pulse current with the duty ratio of 75%. As illustrated in FIG. 9C, a time average (Poave) of light output levels of the light emitting element 10 is smaller than the light output level (Po@duty=25%) and is greater than the light output level (Po@duty=75%).

In addition, FIG. 10 is a diagram illustrating a relationship between a current and a light output level when a single gain region is pulse-driven at the duty ratio of 25%, a relationship between a current and a light output level when a single gain region is pulse-driven at the duty ratio of 75%, and a relationship between a current and a light output level when a single gain region is continuously driven (CW driven).

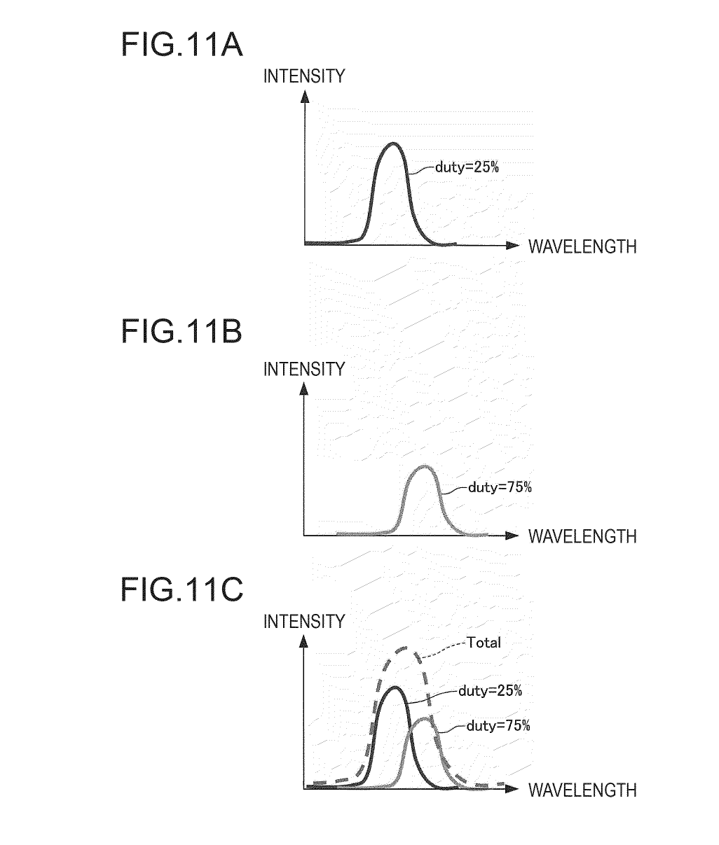

Here, FIGS. 11A to 11C are diagrams illustrating a relationship between a wavelength and a light output level, of light emitted from the illumination device according to Modification Example 1 of the first embodiment.

More specifically, FIG. 11A illustrates a relationship between a wavelength and a light output level, of light emitted when the pulse current with the duty ratio of 25% is supplied as illustrated in FIG. 9A. FIG. 11B illustrates a relationship between a wavelength and a light output level, of light emitted when the pulse current with the duty ratio of 75% is supplied as illustrated in FIG. 9B.

As described above, influence of self heat generation is larger and a temperature of the active layer is higher in a case of the duty ratio of 75% than in a case of the duty ratio of 25%. A refractive index of a material forming the active layer is changed depending on the temperature, and, accordingly, an emission wavelength is changed depending on the active layer temperature. More specifically, as the active layer temperature becomes higher, a wavelength at which a light output level is the maximum is shifted to a longer wavelength side, and heat dissipation deteriorates. For this reason, as illustrated in FIGS. 11A and 11B, a wavelength at which a light output level is the maximum at the duty ratio of 75% is longer than a wavelength at which a light output level is the maximum at the duty ratio of 25%.

As illustrated in FIG. 11C, the light emitting element 10 (the pair of gain regions 170) can emit light obtained by superimposing the light component with the duty ratio of 25% on the light component with the duty ratio of 75% as total emission light.

Therefore, according to the illumination device related to Modification Example 1, a wavelength width of total emission light can be made to be broader than, for example, in the illumination device 100. Accordingly, it is possible to reduce coherence of the total emission light. As a result, it is possible to reduce speckle noise.

### 2. Modification Example 2

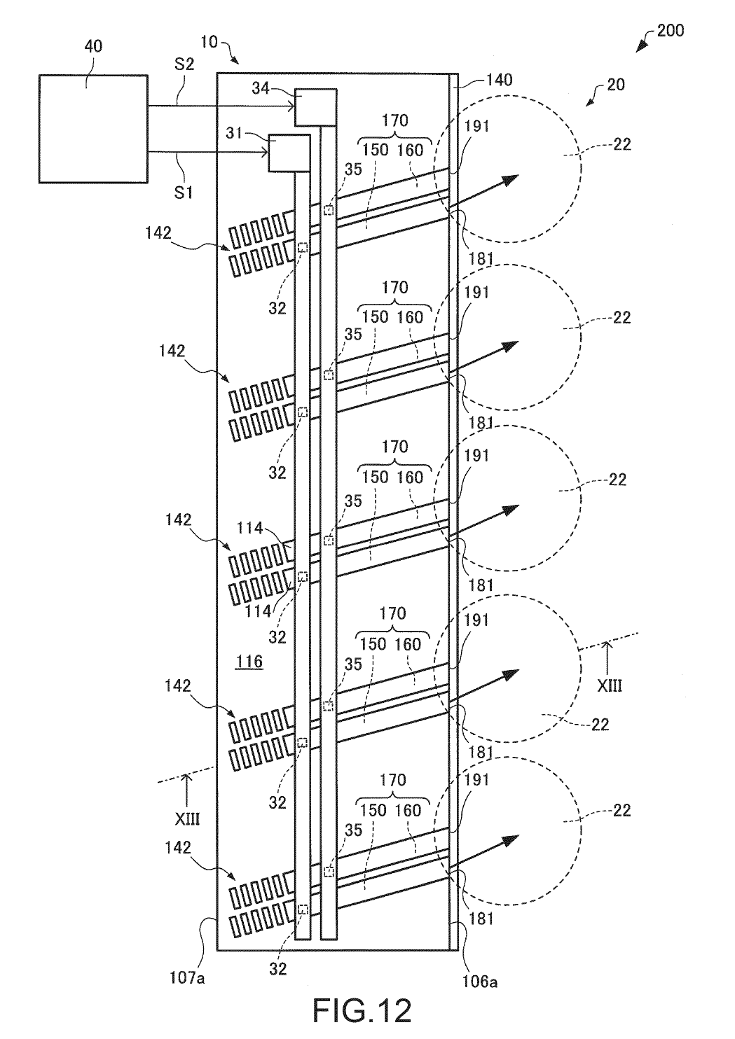

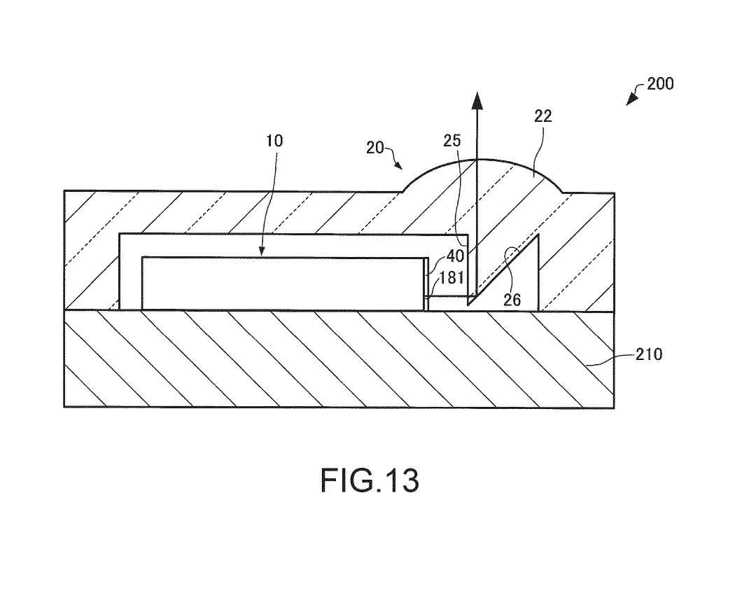

Next, an illumination device 200 according to Modification Example 2 of the first embodiment will be described with reference to the drawings. FIG. 12 is a plan view schematically illustrating the illumination device 200 according to Modification Example 2 of the first embodiment. FIG. 13 is a diagram schematically illustrating the illumination device 200 according to Modification Example 2 of the first embodiment and is a cross-sectional view taken along the line XIII-XIII of FIG. 12. In addition, for convenience of description, a mounting substrate 210 and a lens array 20 are not illustrated in FIG. 12. Further, in FIG. 13, the light emitting element 10 is simplified and illustrated.

Hereinafter, in the illumination device 200 according to Modification Example 2 of the first embodiment, a member having the same function as the constituent member of the illumination device 100 according to the first embodiment is given the same reference numeral, and detailed description will be omitted.

In the illumination device 200, as illustrated in FIGS. 12 and 13, there is a difference from the illumination device 100 in that light emitted from the light emitting portions 181 and 191 is reflected by a reflective surface 26 and is incident to the first lens 22.

The illumination device 200 is mounted on the mounting substrate 210. The illumination device 200 may be mounted so that the upper surface (refer to FIG. 3) of the second electrode 114 faces the mounting substrate 210 side, or may be mounted so that the lower surface (refer to FIG. 3) of the first electrode 112 faces the mounting substrate 210 side. As the mounting substrate 210, for example, a silicon substrate is used.

In addition, although not illustrated, the light emitting element 10 may not be provided with the wires 30 and 33, the pads 31 and 34, and the contact portions 32 and 35, and a plurality of second electrodes 114 may be electrically connected to each other via wires or the like provided in the mounting substrate 210.

The lens array 20 is supported by the mounting substrate 210. The lens array 20 may have a transmissive surface (a light incident surface) 25 and the reflective surface 26.

The reflective surface 26 is provided so as to form an angle of 45°, for example, with the transmissive surface 25. Although not illustrated, an antireflection film may be formed on the transmissive surface 25, and a reflective film may be formed on the reflective surface 26. Accordingly, it is possible to reduce a light loss in the transmissive surface 25 and the reflective surface 26.

Light emitted from the light emitting portions 181 and 191 may be transmitted through the transmissive surface 25 and be reflected by the reflective surface 26. In addition, in a case where an emission direction of light emitted from the light emitting portions 181 and 191 is not perpendicular to the lateral surface 106a (refer to FIG. 1), for example, the light is made to be refracted at the transmissive surface 25 so that a direction of an optical axis is changed to a direction perpendicular to the lateral surface 106a and then the light is reflected at the reflective surface 26. Due to the reflection at the reflective surface 26, light emitted from the light emitting portions 181 and 191 travels toward the first lens 22.

According to the illumination device 200, it is possible to emit light with favorable uniformity in the same manner as the illumination device 100.

### 2. Second Embodiment

### 2.1 Illumination Device

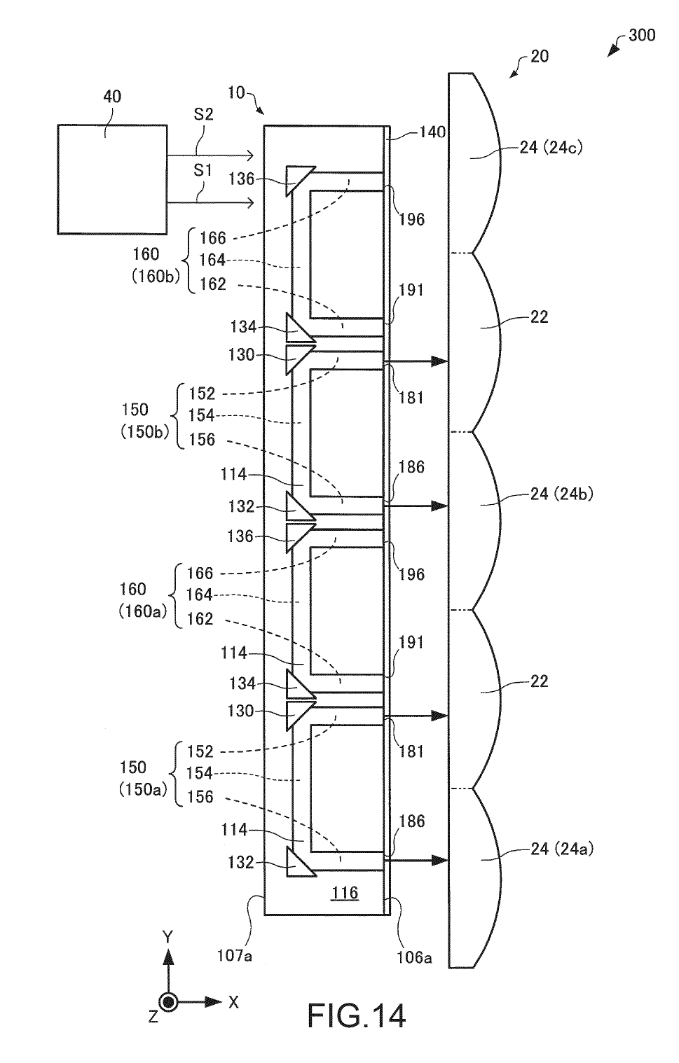

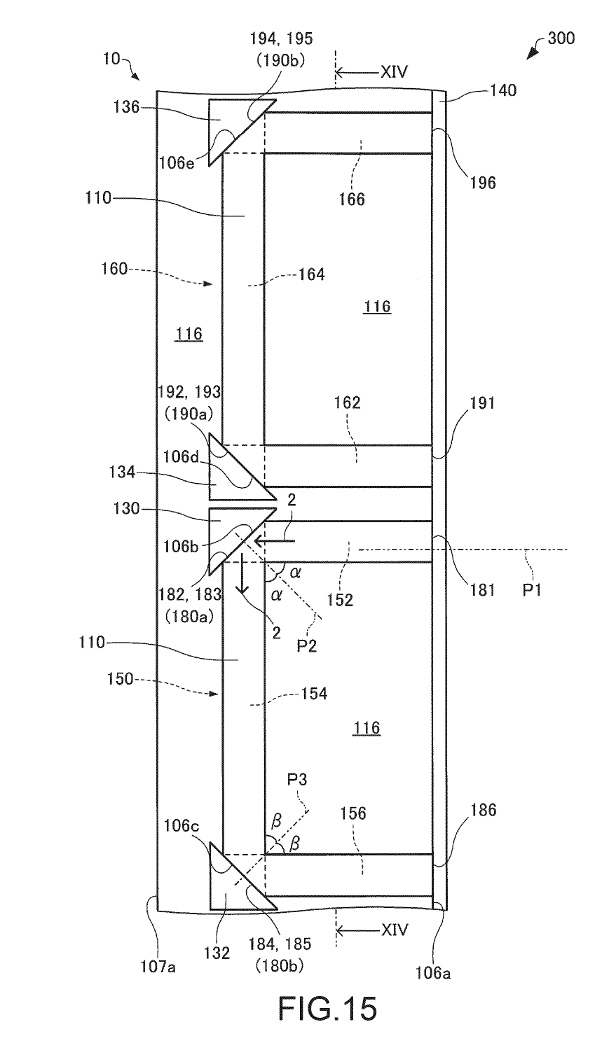

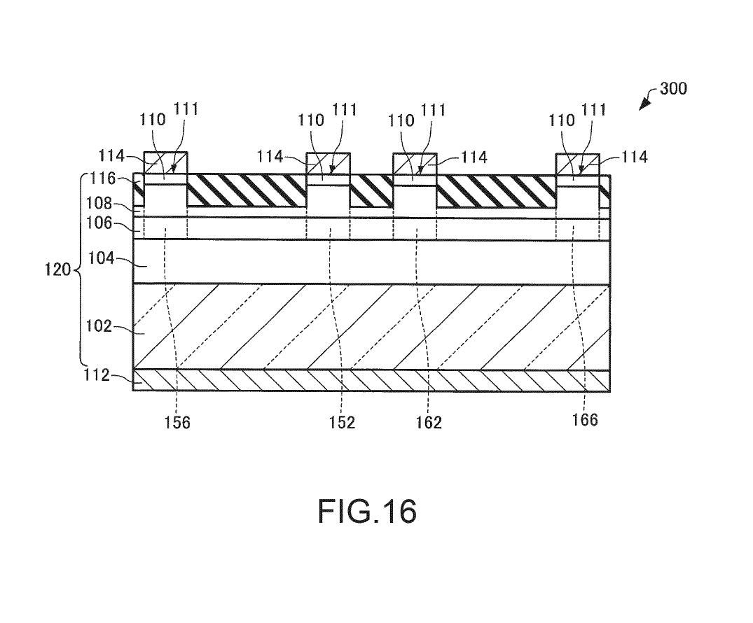

Next, an illumination device 300 according to a second embodiment will be described with reference to the drawings. FIG. 14 is a plan view schematically illustrating the illumination device 300 according to the second embodiment, and corresponds to FIG. 1. FIG. 15 is a plan view schematically illustrating the illumination device 300 according to the second embodiment, and is an enlarged view of FIG. 14. FIG. 16 is a diagram schematically illustrating the illumination device 300 according to the second embodiment, and is a cross-sectional view taken along the line XIV-XIV of FIG. 15. In addition, for convenience of description, wires 30 and 33, pads 31 and 34, and contact portions 32 and 35 are not illustrated in FIGS. 14 to 16. Further, FIG. 14 illustrates an X axis, a Y axis, and a Z axis as three axes perpendicular to each other.

Hereinafter, in the illumination device 300 according to the second embodiment, a member having the same function as the constituent member of the illumination device 100 according to the first embodiment is given the same reference numeral, and detailed description will be omitted.

In the illumination device 300, planar shapes of the gain regions 150 and 160 are different from the illumination device 100. In the illumination device 300, as illustrated in FIGS. 14 and 15, each of the gain regions 150 and 160 has a U shape in a plan view. In other words, the shape is a shape in which a reflective portion is bent twice. Hereinafter, a detailed description thereof will be made.

As illustrated in FIG. 14, opening portions 130, 132, 134 and 136 are formed in the laminate 120. The opening portions 130, 132, 134 and 136 are formed so as to penetrate through, for example, the insulating layer 116, the second clad layer 108, and the active layer 106. The opening portions 130, 132, 134 and 136 may be hollow, or may be filled with a reflective film. A planar shape of each of the opening portions 130, 132, 134 and 136 is not particularly limited, but is a triangular shape in the illustrated example.

As illustrated in FIG. 15, the active layer 106 has a first lateral surface 106a, a second lateral surface 106b, a third lateral surface 106c, a fourth lateral surface 106d, and a fifth lateral surface 106e. In the example illustrated in FIG. 15, the first lateral surface 106a is a surface in the +X axis direction (a surface facing the +X axis direction) of the active layer 106. The second lateral surface 106b specifies a part of the opening portion 130. The third lateral surface 106c specifies a part of the opening portion 132. The fourth lateral surface 106d specifies a part of the opening portion 134. The fifth lateral surface 106e specifies a part of the opening portion 136. The lateral surfaces 106b, 106c, 106d and 106e are tilted with respect to the first lateral surface 106a. The first lateral surface 106a may be a cleavage surface which is formed through cleavage. The lateral surfaces 106b, 106c, 106d and 106e may be an etched surface which is formed through etching.

The active layer 106 has a first gain region 150 and a second gain region 160. In the example illustrated in FIG. 14, each of the gain regions 150 and 160 is provided in plurality, and a plurality of gain regions 150 and 160 are alternately provided at equal intervals along the Y axis. More specifically, the gain regions 150 and 160 are disposed in the +Y axis direction in order of a first gain region 150a, a second gain region 160a, a first gain region 150b, and a second gain region 160b.

The first gain region 150 has a first gain section 152, a second gain section 154, and a third gain section 156 as illustrated in FIG. 15.

The first gain section 152 extends from the first lateral surface 106a to the second lateral surface 106b in a plan view. The first gain section 152 has a predetermined width in a plan view, and has a longitudinal shape formed in a strip shape and a linear shape in an extension direction of the first gain section 152. The first gain section 152 has an end surface 181 provided at a connection part with the first lateral surface 106a and an end surface 182 provided at a connection part with the second lateral surface 106b.

In addition, the extension direction of the first gain section 152 may be an extension direction of a straight line which passes through a center of the end surface 181 and a center of the end surface 182 in a plan view. Further, the extension direction of the first gain section 152 may be an extension direction of a boundary of the first gain section 152 (and a part excluding the first gain section 152).

Similarly, also in the other gain sections, the extension direction may be an extension direction of a straight line passing through centers of two end surfaces in a plan view. In addition, the extension direction may be a direction of a boundary of the gain section (and a part excluding the gain section).

In the example illustrated in FIG. 15, the first gain section 152 is connected vertically to the first lateral surface 106a in a plan view. In other words, the extension direction of the first gain section 152 is a direction of a perpendicular line P1 of the first lateral surface 106a.

The first gain section 152 is tilted with an angle α with respect to a perpendicular line P2 of the second lateral surface 106b and is connected to the second lateral surface 106b. In other words, it can be said that the extension direction of the first gain section 152 has an angle of a with respect to the perpendicular line P2.

The second gain section 154 extends from the second lateral surface 106b to the third lateral surface 106c in a plan view. The second gain section 154 has a predetermined width in a plan view, and has a longitudinal shape formed in a strip shape and a linear shape in the extension direction of the second gain section 154. The second gain section 154 has an end surface 183 provided at a connection part with the second lateral surface 106b and an end surface 184 provided at a connection part with the third lateral surface 106c. The extension direction of the second gain section 154 is parallel to the first lateral surface 106a in a plan view.

Further, the meaning in which “the extension direction of the second gain section 154 is parallel to the first lateral surface 106a” is that a tilt angle of the second gain section 154 for the first lateral surface 106a is within ±1° in a plan view in consideration of manufacturing variations or the like.

The end surface 183 of the second gain section 154 overlaps the end surface 182 of the first gain section 152 in the second lateral surface 106b. In the illustrated example, the end surface 182 and the end surface 183 completely overlap each other in an overlapping surface 180a.

The second gain section 154 is tilted with an angle of α with respect to the perpendicular line P2 of the second lateral surface 106b, and is connected to the second lateral surface 106b, in a plan view. In other words, it can be said that the extension direction of the second gain section 154 has an angle of α with respect to the perpendicular line P2. That is, an angle for the perpendicular line P2 of the first gain section 152 and an angle for the perpendicular line P2 of the second gain section 154 are the same as each other in a range of manufacturing variations. The angle α is, for example, an acute angle, and is equal to or more than a threshold angle. Accordingly, the second lateral surface 106b can totally reflect light generated in the first gain region 150. More specifically, a value of the angle α is 45°.

In addition, the meaning in which “the angle θ1 and the angle θ2 are the same as each other in a range of manufacturing variations” is that a difference between both the angles is, for example, within about ±2° in consideration of manufacturing variations such as etching.

The second gain section 154 is tilted with an angle of β (=90−α) with respect to a perpendicular line P3 of the third lateral surface 106c, and is connected to the third lateral surface 106c, in a plan view. In other words, it can be said that the extension direction of the second gain section 154 has an angle of β with respect to the perpendicular line P3.

A length in the extension direction of the second gain section 154 is larger than a length in the extension direction of the first gain section 152 and a length in the extension direction of the third gain section 156. In addition, the “length in the extension direction of the second gain section 154” may be a distance between the center of the end surface 183 and the center of the end surface 184. Similarly, in the same manner for the other gain sections, a length in the extension direction may be a distance between the centers of two end surfaces.

The third gain section 156 extends from the third lateral surface 106c to the first lateral surface 106a in a plan view. The third gain section 156 has a predetermined width in a plan view, and has a longitudinal shape formed in a strip shape and a linear shape in the extension direction of the third gain section 156. The third gain section 156 has an end surface 185 provided at a connection part with the third lateral surface 106c and an end surface 186 provided at a connection part with the first lateral surface 106a.

The end surface 185 of the third gain section 156 overlaps the end surface 184 of the second gain section 154 in the third lateral surface 106c. In the illustrated example, the end surface 184 and the end surface 185 completely overlap each other in an overlapping surface 180b.

The third gain section 156 is tilted with an angle of β with respect to the perpendicular line P3 of the third lateral surface 106c, and is connected to the third lateral surface 106c, in a plan view. In other words, it can be said that the extension direction of the third gain section 156 has an angle of β with respect to the perpendicular line P3. That is, an angle for the perpendicular line P3 of the second gain section 154 and an angle for the perpendicular line P3 of the third gain section 156 are the same as each other in a range of manufacturing variations. Accordingly, the third lateral surface 106c can totally reflect light generated in the first gain region 150.

In the example illustrated in FIG. 15, the third gain section 156 is connected vertically to the first lateral surface 106a in a plan view. In other words, the extension direction of the third gain section 156 is a direction of a perpendicular line P1 of the first lateral surface 106a. Therefore, the first gain section 152 and the third gain section 156 are parallel to each other in a plan view. More specifically, the extension direction of the first gain section 152 and the extension direction of the third gain section 156 are parallel to each other. Accordingly, light emitted from the end surface 181 and light emitted from the end surface 186 can be emitted in the same direction.

As described above, the angle α and the angle β are made to be equal to or more than a threshold angle, and thus a reflectance of the first lateral surface 106a can be made to be lower than a reflectance of the second lateral surface 106b and a reflectance of the third lateral surface 106c in light generated in the first gain region 150. In other words, the end surface 181 provided on the first lateral surface 106a can be a first light emitting portion which emits light generated in the first gain region 150. The end surface 186 provided on the first lateral surface 106a can be a third light emitting portion which emits light generated in the first gain region 150. The overlapping surface 180a of the end surfaces 182 and 183 provided on the second lateral surface 106b can be a first reflective portion which reflects light generated in the first gain region 150. The overlapping surface 180b of the end surfaces 184 and 185 provided on third lateral surface 106c can be a second reflective portion which reflects light generated in the first gain region 150.

In other words, the first gain section 152 extends from the first light emitting portion 181 to the first reflective portion 180a. The second gain section 154 extends from the first reflective portion 180a to the second reflective portion 180b. The third gain section 156 extends from the second reflective portion 180b to the third light emitting portion 186. Therefore, it can be said that the first gain region 150 has a U shape (a U shape having corners) in a plan view. The first gain region 150 connects the first light emitting portion 181 to the third light emitting portion 186.

The light emitting portions 181 and 186 are covered by the antireflection film 140. Therefore, it is possible to reduce direct multiple reflection of light generated in the first gain region 150 between the end surface 181 and the end surface 186. As a result, since a direct resonator can be made not to be formed, it is possible to suppress laser oscillation of light generated in the first gain region 150.

In addition, although not illustrated, the reflective portions 180a and 180b may be covered by a reflective film. Accordingly, a reflectance of the first lateral surface 106a in a wavelength band of light generated in the first gain region 150 can be made to be lower than a reflectance of the second lateral surface 106b and a reflectance of the third lateral surface 106c even in conditions such as an incidence angle and a refractive index at which total reflection does not occur in the light generated in the first gain region 150 in the reflective portions 180a and 180b. Further, a high reflectance may be obtained using a distributed Bragg reflector (DBR) which is formed by etching the lateral surfaces 106b and 106c.

In addition, although not illustrated, the first gain section 152 and the third gain section 156 may be tilted with a predetermined angle and may be connected to the first lateral surface 106a. Accordingly, it is possible to more reliably prevent direct multiple reflection of light generated in the first gain region 150 between the end surfaces 181 and 186.

For example, as illustrated in FIG. 15, light 2, which is generated in the first gain section 152 and is directed toward the second lateral surface 106b, is amplified inside the first gain section 152 so as to be then reflected at the first reflective portion 180a, and is directed toward the third lateral surface 106c so as to travel through the second gain section 154. In addition, the light 2 is further reflected at the second reflective portion 180b so as to travel through the third gain section 156, and is then emitted from the end surface 186. At this time, a light intensity is also amplified inside the gain sections 154 and 156.

Similarly, light, which is generated in the third gain section 156 and is directed toward the third lateral surface 106c, is amplified inside the third gain section 156 so as to be then reflected at the second reflective portion 180b, and is directed toward the second lateral surface 106b so as to travel through the second gain section 154. In addition, the light is further reflected at the first reflective portion 180a so as to travel through the first gain section 152, and is emitted from the end surface 181. At this time, a light intensity is also amplified inside the gain sections 152 and 154.

In addition, light generated in the first gain section 152 may be directly emitted from the end surface 181. Similarly, light generated in the third gain section 156 may be directly emitted from the end surface 186. A light intensity of the light is also amplified inside each of the gain sections 152 and 156 in the same manner.

As illustrated in FIG. 15, the second gain region 160 has a fourth gain section 162, a fifth gain section 164, and a sixth gain section 166.

The fourth gain section 162 extends from an end surface 191 (a second light emitting portion) provided on the first lateral surface 106a to an end surface 192 (a third reflective portion 190a) provided on the fourth lateral surface 106d in a plan view. The fourth gain section 162 has a longitudinal shape formed in a strip shape and a linear shape in an extension direction of the fourth gain section 162.

The fifth gain section 164 extends from an end surface 193 (a third reflective portion 190a) provided on the fourth lateral surface 106d to an end surface 194 (a fourth reflective portion 190b) provided on the fifth lateral surface 106e in a plan view. The fifth gain section 164 has a longitudinal shape formed in a strip shape and a linear shape in an extension direction of the fifth gain section 164.

The end surface 193 of the fifth gain section 164 overlaps the end surface 192 of the fourth gain section 162 in the fourth lateral surface 106d. In the illustrated example, the end surface 192 and the end surface 193 completely overlap each other in an overlapping surface 190a.

The sixth gain section 166 extends from an end surface 195 (the fourth reflective portion 190b) provided on the fifth lateral surface 106e to an end surface 196 (the fourth reflective portion) provided on the first lateral surface 106a in a plan view. The sixth gain section 166 has a longitudinal shape formed in a strip shape and a linear shape in an extension direction of the sixth gain section 166.

The end surface 195 of the sixth gain section 166 overlaps the end surface 194 of the fifth gain section 164 in the fifth lateral surface 106e. In the illustrated example, the end surface 194 and the end surface 195 completely overlap each other in an overlapping surface 190b.

The second gain region 160 connects the second light emitting portion 191 to the fourth light emitting portion 196. It can be said that a shape of the second gain region 160 is basically the same as the shape of the first gain region 150, and has a U shape (a U shape having corners) in a plan view. Therefore, detailed description thereof will be omitted.

In the example illustrated in FIG. 14, in the gain regions 150a and 160a adjacent to each other, a gap between the light emitting portions 181 and 191 is smaller than a gap between the light emitting portions 181 and 186 and a gap between the light emitting portions 191 and 196. In the gain regions 160a and 150b adjacent to each other, a gap between the light emitting portions 186 and 196 is smaller than a gap between the light emitting portions 181 and 186 and a gap between the light emitting portions 191 and 196. In the gain regions 150b and 160b adjacent to each other, a gap between the light emitting portions 181 and 191 is smaller than a gap between the light emitting portions 181 and 186 and a gap between the light emitting portions 191 and 196.

In the illumination device 300, light emitted from the first light emitting portion 181, light emitted from the second light emitting portion 191, light emitted from the third light emitting portion 186, and light emitted from the fourth light emitting portion 196 can be emitted in the same direction.

The lens array 20 has a first lens 22 and a second lens 24. In the example illustrated in FIG. 14, each of the lenses 22 and 24 is provided in plurality, and a plurality of lenses 22 and 24 are alternately provided along the Y axis. The first lens 22 and the second lens 24 have the same shape. More specifically, the lenses 22 and 24 are disposed in the +Y axis direction in order of the second lens 24a, the first lens 22, the second lens 24b, the first lens 22, and the second lens 24c.

Light emitted from the first light emitting portion 181 of the first gain region 150 and light emitted from the second light emitting portion 191 of the second gain region 160 are incident to the first lens 22. At least one of light emitted from the third light emitting portion 186 of the first gain region 150 and light emitted from the fourth light emitting portion 196 of the second gain region 160 is incident to the second lens 24. In the illustrated example, light emitted from the third light emitting portion 186 of the first gain region 150a is incident to the second lens 24a. Light emitted from the fourth light emitting portion 196 of the second gain region 160a and light emitted from the third light emitting portion 186 of the first gain region 150b are incident to the second lens 24b. Light emitted from the fourth light emitting portion 196 of the second gain region 160b is incident to the second lens 24c.

The control unit 40 can operate the light emitting element 10 so that light is alternately generated in the first gain region 150 and the second gain region 160. Accordingly, the light emitting element 10 can alternately emit light from the light emitting portions 181 and 186 and the light emitting portions 191 and 196. In addition, the light emitted from the light emitting portions 181 and 186 and the light emitted from the light emitting portions 191 and 196 can be alternately incident to the lens array 20 (the lenses 22 and 24). In addition, in the example illustrated in FIG. 14, a case where light is emitted from the light emitting portions 181 and 186 is illustrated.

The illumination device 300 according to the second embodiment has the following features, for example.

According to the illumination device 300, it is possible to emit light with favorable uniformity, in the same manner as the illumination device 100. According to the illumination device 300, the first gain region 150 has the first gain section 152 which extends from the first light emitting portion 181 to the first reflective portion 180a, the second gain section 154 which extends from the first reflective portion 180a to the second reflective portion 180b, and the third gain section 156 which extends from the second reflective portion 180b to the third light emitting portion 186. The second gain region 160 has the fourth gain section 162 which extends from the second light emitting portion 191 to the third reflective portion 190a, the fifth gain section 164 which extends from the third reflective portion 190a to the fourth reflective portion 190b, and the sixth gain section 166 which extends from the fourth reflective portion 190b to the fourth light emitting portion 196. For this reason, in the illumination device 300, a gap between the light emitting portions 181 and 196 can be adjusted by adjusting the length of the second gain section 154. In addition, a gap between the light emitting portions 191 and 196 can be adjusted by adjusting the length of the fifth gain section 164. Accordingly, in the illumination device 300, it is possible to easily adjust a gap between the light emitting portions 181 and 186 and a gap between the light emitting portions 191 and 196 so as to match the sizes of the lenses 22 and 24.

Further, according to the illumination device 300, it is possible to reduce a size thereof in the X axis direction and to increase an overall length of the gain regions 150 and 160 as compared with the illumination device 100. For this reason, it is possible to obtain a high output level.

### 2.2 Manufacturing Method of Illumination Device

Next, a manufacturing method of the illumination device according to the second embodiment will be described. A manufacturing method of the illumination device 300 according to the second embodiment is basically the same as the manufacturing method of the illumination device 100 according to the first embodiment. Therefore, description thereof will be omitted.

### 2.3 Modification Examples of Illumination Device

### 1. Modification Example 1

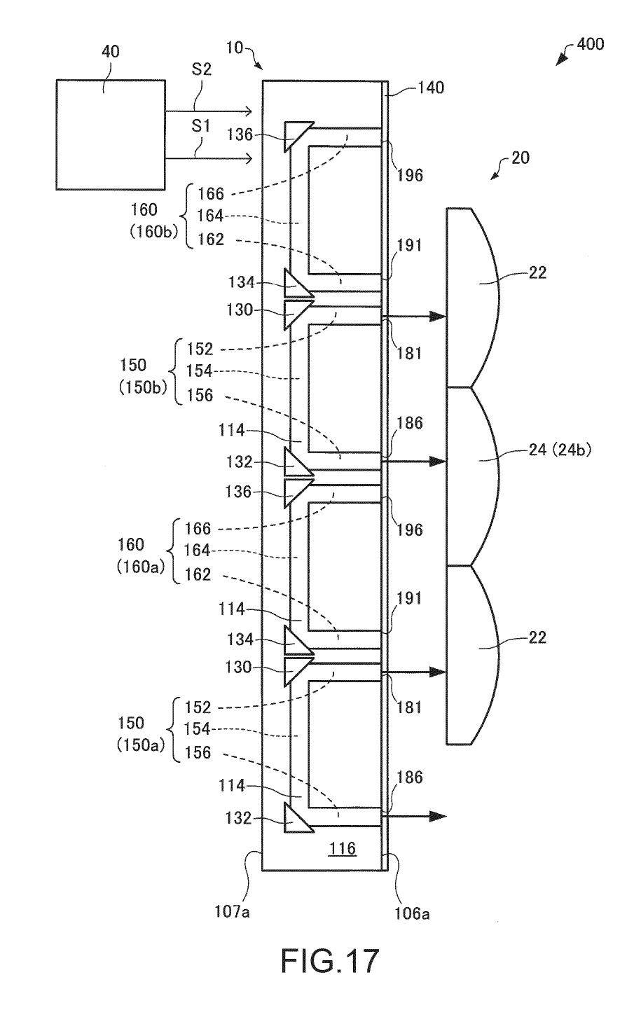

Next, an illumination device 400 according to Modification Example 1 of the second embodiment will be described with reference to the drawings. FIG. 17 is a plan view schematically illustrating the illumination device 400 according to Modification Example 1 of the second embodiment. In addition, for convenience of description, wires 30 and 33, pads 31 and 34, and contact portions 32 and 35 are not illustrated in FIG. 17.

Hereinafter, in the illumination device 400 according to Modification Example 1 of the second embodiment, a member having the same function as the constituent member of the illumination device 300 according to the second embodiment is given the same reference numeral, and detailed description will be omitted.

In the illumination device 300, as illustrated in FIG. 14, the lens array 20 has the second lenses 24a and 24c to which only one of light emitted from the light emitting portion 186 and light emitted from the light emitting portion 196 is incident.

In contrast, in the illumination device 400, as illustrated in FIG. 17, both of light emitted from the light emitting portion 186 and light emitted from the light emitting portion 196 are incident to all of the second lenses 24 forming the lens array 20. In the illustrated example, light emitted from the third light emitting portion 186 of the first gain region 150a and light emitted from the fourth light emitting portion 196 of the second gain region 160b are not incident to the lens array 20.

According to the illumination device 400, light beams emitted from the different light emitting portions are alternately incident to the lenses 22 and 24 forming the lens array 20. For this reason, the illumination device 400 can emit light with more favorable uniformity from the lens array 20 than, for example, the illumination device 300.

### 2. Modification Example 2

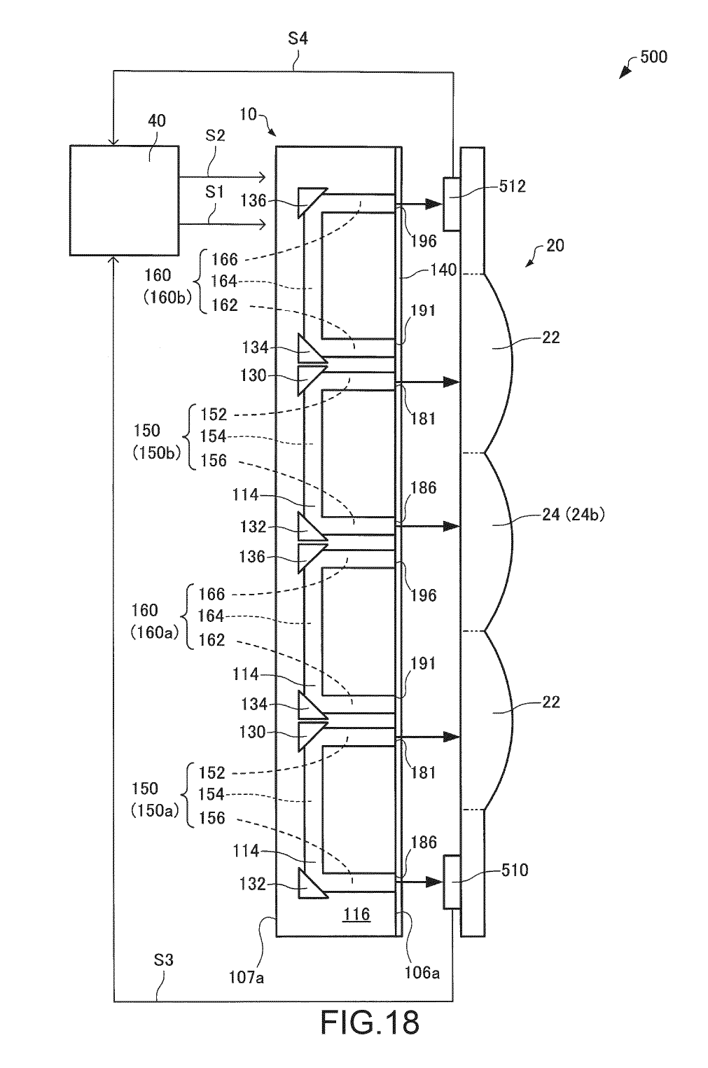

Next, an illumination device 500 according to Modification Example 2 of the second embodiment will be described with reference to the drawings. FIG. 18 is a plan view schematically illustrating the illumination device 500 according to Modification Example 2 of the second embodiment. In addition, for convenience of description, wires 30 and 33, pads 31 and 34, and contact portions 32 and 35 are not illustrated in FIG. 18.

Hereinafter, in the illumination device 500 according to Modification Example 2 of the second embodiment, a member having the same function as the constituent member of the illumination device 300 according to the second embodiment is given the same reference numeral, and detailed description will be omitted.

In the illumination device 300, as illustrated in FIG. 14, light emitted from the third light emitting portion 186 of the first gain region 150a and light emitted from the fourth light emitting portion 196 of the second gain region 160b are incident to the second lenses 24.

In contrast, in the illumination device 500, as illustrated in FIG. 18, light emitted from the third light emitting portion 186 of the first gain region 150a is incident to a light detection portion 510, and light emitted from the fourth light emitting portion 196 of the second gain region 160b is incident to a light detection portion 512. The light detection portions 510 and 512 are, for example, photodiodes.

The control unit 40 operates the light emitting element 10 on the basis of light detected by the light detection portions 510 and 512. More specifically, the light detection portions 510 and 512 output signals (more specifically, currents) S3 and S4 on the basis of the incident light. The control unit 40 supplies the driving signals S1 and S2 on the basis of the signals S3 and S4. Accordingly, the illumination device 500 can perform automatic power control (APC) driving. Therefore, the illumination device 500 can maintain a light output level to be more stable than, for example, the illumination device 300. The light emitting portions 181 and 186 are the end surface of the same first gain region 150, and thus output levels of light beams emitted from the light emitting portions 181 and 186 are fundamentally the same as each other. Similarly, output levels of light beams emitted from the light emitting portions 191 and 196 are fundamentally the same as each other. For this reason, it is possible to more reliably maintain a light output level of the illumination device 500 to be stable due to the APC driving.

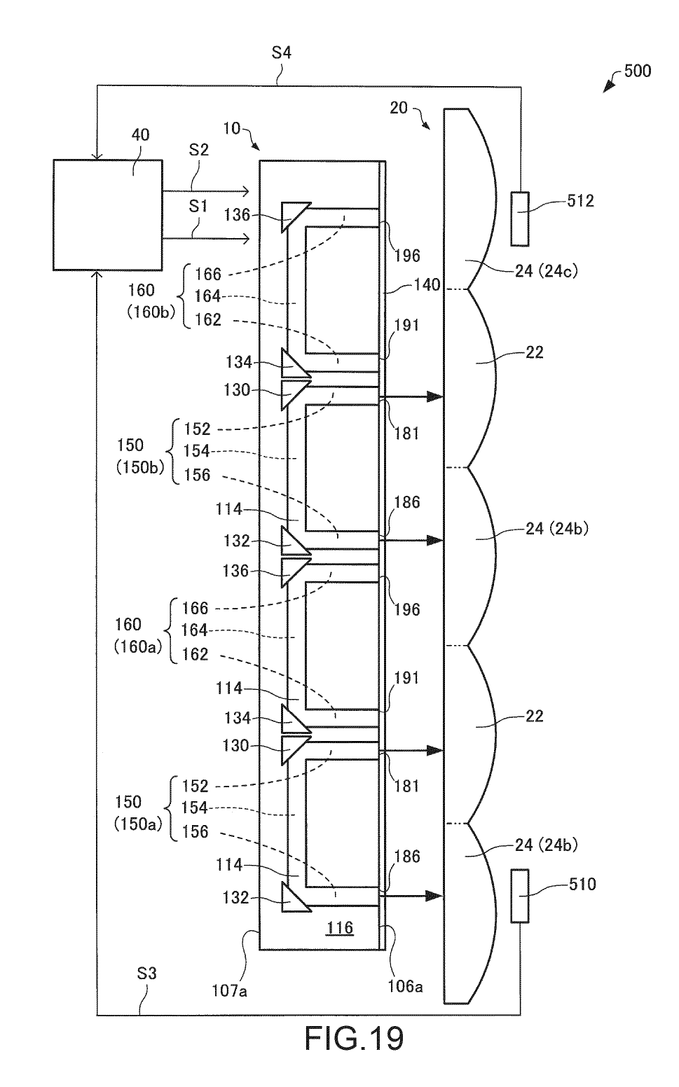

In addition, as illustrated in FIG. 19, the light detection portions 510 and 512 may be provided in a rear stage of the lens array 20. In other words, light emitted from the third light emitting portion 186 of the first gain region 150a and light emitted from the fourth light emitting portion 196 of the second gain region 160b may be transmitted through the lens array 20 and then may be incident to the light detection portions 510 and 512.

### 3. Modification Example 3

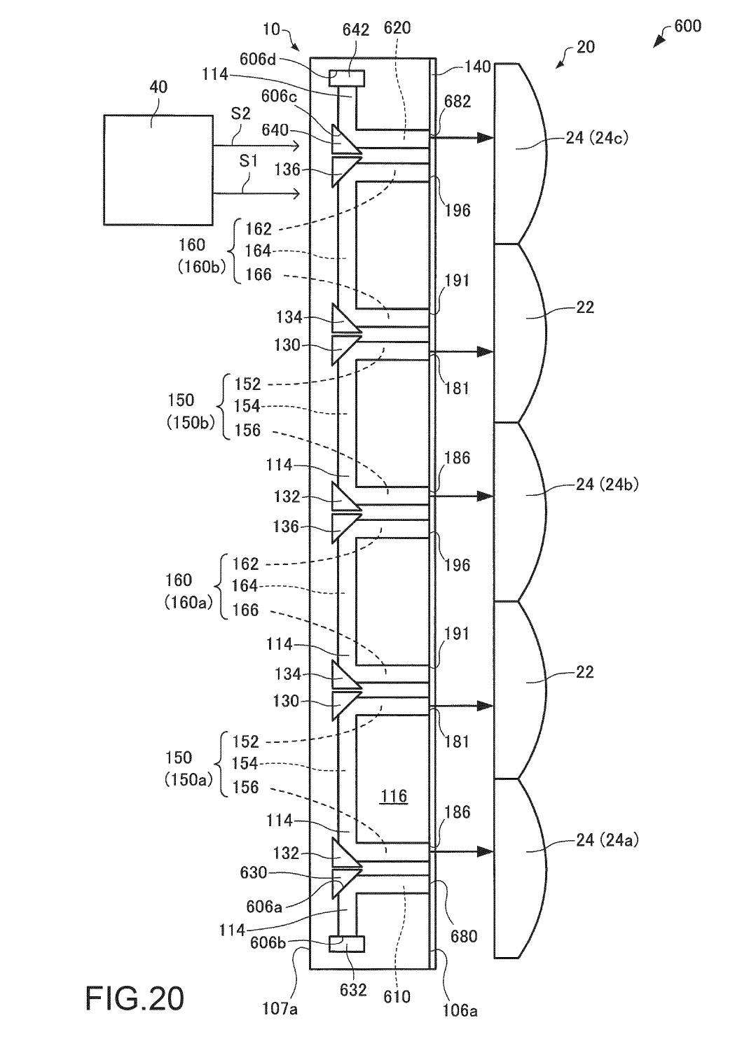

Next, an illumination device 600 according to Modification Example 3 of the second embodiment will be described with reference to the drawing. FIG. 20 is a plan view schematically illustrating the illumination device 600 according to Modification Example 3 of the second embodiment. In addition, for convenience of description, wires 30 and 33, pads 31 and 34, and contact portions 32 and 35 are not illustrated in FIG. 20.

Hereinafter, in the illumination device 600 according to Modification Example 3 of the second embodiment, a member having the same function as the constituent member of the illumination device 300 according to the second embodiment is given the same reference numeral, and detailed description will be omitted.

In the illumination device 300, as illustrated in FIG. 14, only light emitted from the third light emitting portion 186 is incident to the second lens 24a, and only light emitted from the fourth light emitting portion 196 is incident to the second lens 24c.

In contrast, in the illumination device 600, as illustrated in FIG. 20, light beams emitted from light emitting portions 186 and 680 are incident to the second lens 24a, and light beams emitted from light emitting portions 196 and 682 are incident to the second lens 24c.

Opening portions 630, 632, 640 and 642 are formed in the laminate 120. The opening portions 630, 632, 640 and 642 are formed so as to penetrate through, for example, the insulating layer 116, the second clad layer 108, and the active layer 106. The opening portions 630, 632, 640 and 642 may be hollow, or may be filled with a reflective film.

A part of the active layer 106 forms a third gain region 610 and a fourth gain region 620. The gain regions 610 and 620 can generate light when currents flow therethrough, and the light can be guided through the gain regions 610 and 620 while receiving a gain.

In the illustrated example, an extension direction of a part of the third gain region 610 connected to the lateral surface 106a is perpendicular to the lateral surface 106a. The third gain region 610 extends from the lateral surface 106a to a lateral surface 606a of the active layer 106 specifying a part of the opening portion 630, and is further bent at the lateral surface 606a so as to extend to a lateral surface 606b of the active layer 106 specifying a part of the opening portion 632. The end surface 680 provided on the lateral surface 106a of the third gain region 610 is a fifth light emitting portion. Light emitted from the fifth light emitting portion 680 is incident to the second lens 24a.

An extension direction of a part of the fourth gain region 620 connected to the lateral surface 106a is perpendicular to the lateral surface 106a. The fourth gain region 620 extends from the lateral surface 106a to a lateral surface 606c of the active layer 106 specifying a part of the opening portion 640, and is further bent at the lateral surface 606c so as to extend to a lateral surface 606d of the active layer 106 specifying a part of the opening portion 642. The end surface 682 provided on the lateral surface 106a of the fourth gain region 620 is a sixth light emitting portion. Light emitted from the sixth light emitting portion 682 is incident to the second lens 24c.

Light beams emitted from the light emitting portions 680 and 682 can be emitted in the same direction as light beams emitted from the light emitting portions 181, 186, 191 and 196. For example, a length of the third gain region 610 (a length in the extension direction thereof) and a length of the fourth gain region 620 are a half of the length of the first gain region 150 and the length of the second gain region 160. Therefore, intensities of light beams emitted from the light emitting portions 181, 186, 191, 196, 680 and 682 can be made to be the same as each other.

The second electrode 114 formed over the third gain region 610 is electrically connected to the second electrode 114 formed over the second gain region 160 via a wire (not illustrated). The second electrode 114 formed over the fourth gain region 620 is electrically connected to the second electrode 114 formed over the first gain region 150 via a wire (not illustrated).

The control unit 40 operates the light emitting element 10 so that light is alternately emitted in the gain regions 150 and 620 and the gain regions 160 and 610. Accordingly, the light emitting element 10 can alternately emit light from the light emitting portions 181, 186 and 682 and the light emitting portions 191, 196 and 680. In addition, the light emitted from the light emitting portions 181, 186 and 682 and the light emitted from the light emitting portions 191, 196 and 680 can be alternately incident to the lens array (the lenses 22 and 24). In addition, in the example illustrated in FIG. 20, a case where light is emitted from the light emitting portions 181, 186 and 682 is illustrated.

According to the illumination device 600, light beams emitted from the different light emitting portions are alternately incident to the lenses 22 and 24 forming the lens array 20. For this reason, the illumination device 600 can emit light with more favorable uniformity from the lens array 20 than, for example, the illumination device 300.

### 3. Third Embodiment

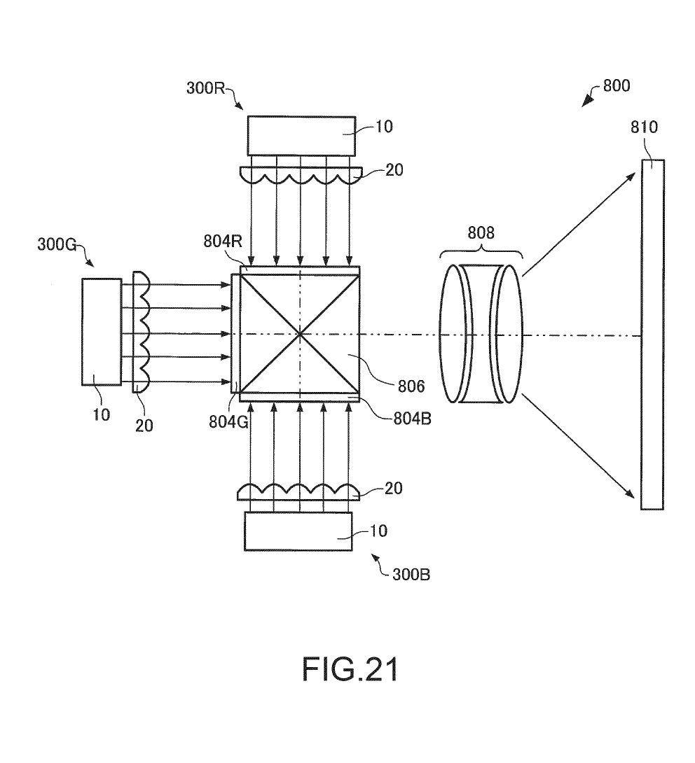

Next, a projector according to the third embodiment will be described with reference to the drawing. FIG. 21 is a diagram schematically illustrating a projector 800 according to the third embodiment. In addition, for convenience of description, a casing forming the projector 800 is not illustrated in FIG. 21.

The projector 800 includes the illumination device according to the embodiments of the invention as a light source module. In the following, as illustrated in FIG. 21, a description will be made of the projector 800 including the illumination devices 300 (the illumination device 300R, the illumination device 300G, and the illumination device 300B). The illumination device 300R, the illumination device 300G, and the illumination device 300B can respectively emit red light, green light, and blue light. In addition, for convenience of description, the illumination device 300R, the illumination device 300G, and the illumination device 300B are simplified and illustrated in FIG. 21.

As illustrated in FIG. 21, the projector 800 further includes a transmissive liquid crystal light valves (spatial light modulation devices) 804R, 804G and 804B, and a projection lens (a projection device) 808.

Light beams emitted from the illumination devices 300R, 300G and 300B are respectively incident to the liquid crystal light valves 804R, 804G and 804B. The respective liquid crystal light valves 804R, 804G and 804B modulate the incident light beams according to image information. In addition, the projection lens 808 enlarges images formed by the liquid crystal light valves 804R, 804G and 804B and projects the images on a screen (a display surface) 810.

In addition, the projector 800 may include a cross dichroic prism (a color light combination unit) 806 which combines light beams emitted from the liquid crystal light valves 804R, 804G and 804B and guides the combined light to the projection lens 808.

Three color light beams modulated by the respective liquid crystal light valves 804R, 804G and 804B are incident to the cross dichroic prism 806. The prism is formed by joining four right-angle prisms together, and a dielectric multilayer film which reflects red light and a dielectric multilayer film which reflects blue light are disposed in a cross shape in the inside thereof. Three color light beams are combined by the dielectric multilayer films so as to form light representing a color image. In addition, the combined light is projected onto the screen 810 by the projection lens 808 which is a projection optical system, and thus an enlarged image is displayed.

The projector 800 includes the illumination device 300 which can emit light with favorable uniformity. For this reason, the projector 800 can reduce uneven luminance.

In addition, although, in the above-described example, the transmissive liquid crystal light valve is used as a spatial light modulation device, a light valve other than the liquid crystal light valve may be used, or a reflective light valve may be used. This light valve may include, for example, a reflective liquid crystal light valve, or a digital micromirror device. Further, a configuration of the projection optical system is appropriately changed depending on the kind of light valve to be used.

In addition, the illumination devices 300R, 300G and 300B are also applicable to an illumination device of a scanning type image display apparatus (a projector) which displays an image with a desired size on a display surface by scanning light from a light source on a screen.

The above-described embodiments and Modification Examples are only an example, and the invention is not limited thereto. For example, the respective embodiments and respective Modification Examples may be appropriately combined together.

The invention includes substantially the same configuration (for example, a configuration in which a function, a method, and a result are the same, or a configuration in which an object and an effect are the same) as the configuration described in the embodiments. In addition, the invention includes a configuration in which an unessential part of the configuration described in the embodiments is replaced. Further, the invention includes a configuration which achieves the same operation and effect or can achieve the same object as the configuration described in the embodiments. Furthermore, the invention includes a configuration in which a well-known technique is added to the configuration described in the embodiments.

The entire disclosure of Japanese Patent Application No. 2013-000351 filed Jan. 7, 2013 is expressly incorporated by reference herein.

What is claimed is:

1. An illumination device comprising:
a light emitting element that includes an active layer, a first clad layer and a second clad layer with the active layer interposed therebetween, and a first gain region and a second gain region generating light when a current flows through the active layer;
a control unit that operates the light emitting element so that light is alternately generated in the first gain region and the second gain region; and
a first lens to which light emitted from a first light emitting portion of the first gain region and light emitted from a second light emitting portion of the second gain region are incident,
wherein the light emitted from the first light emitting portion and the light emitted from the second light emitting portion are emitted in the same direction and are incident to the first lens.

2. The illumination device according to claim 1,
wherein the first light emitting portion and the second light emitting portion are provided on a first lateral surface of the active layer,
wherein the first gain region connects the first light emitting portion to a third light emitting portion provided on the first lateral surface of the active layer,
wherein the second gain region connects the second light emitting portion to a fourth light emitting portion provided on the first lateral surface of the active layer, and
wherein the light emitted from the first light emitting portion, the light emitted from the second light emitting portion, light emitted from the third light emitting portion, and light emitted from the fourth light emitting portion are emitted in the same direction.

3. The illumination device according to claim 2, further comprising:
a second lens to which the light emitted from the third light emitting portion is incident.

4. The illumination device according to claim 2, further comprising:
a light detection portion to which the light emitted from the fourth light emitting portion is incident,
wherein the control unit operates the light emitting element on the basis of light detected by the light detection portion.

5. The illumination device according to claim 1,
wherein the first gain region and the second gain region have a U shape when viewed from a direction in which the first clad layer, the active layer, and the second clad layer are laminated.

6. The illumination device according to claim 1,
wherein the control unit operates the light emitting element so that an emission time of the first gain region and an emission time of the second gain region are the same as each other.

7. The illumination device according to claim 1,
wherein the control unit operates the light emitting element so that an emission time of the first gain region and an emission time of the second gain region are different from each other.

8. The illumination device according to claim 1,
wherein the light emitting element is a super luminescent diode.

9. A projector comprising:
the illumination device according to claim 1;
a spatial light modulation device that modulates light emitted from the illumination device according to image information; and
a projection device that projects an image formed by the spatial light modulation device.

10. A projector comprising:
the illumination device according to claim 2;
a spatial light modulation device that modulates light emitted from the illumination device according to image information; and
a projection device that projects an image formed by the spatial light modulation device.

11. A projector comprising:
the illumination device according to claim 3;
a spatial light modulation device that modulates light emitted from the illumination device according to image information; and
a projection device that projects an image formed by the spatial light modulation device.

12. A projector comprising:
the illumination device according to claim 4;
a spatial light modulation device that modulates light emitted from the illumination device according to image information; and
a projection device that projects an image formed by the spatial light modulation device.

13. A projector comprising:
the illumination device according to claim 5;
a spatial light modulation device that modulates light emitted from the illumination device according to image information; and
a projection device that projects an image formed by the spatial light modulation device.

14. A projector comprising:
the illumination device according to claim 6;
a spatial light modulation device that modulates light emitted from the illumination device according to image information; and
a projection device that projects an image formed by the spatial light modulation device.

15. A projector comprising:
the illumination device according to claim 7;
a spatial light modulation device that modulates light emitted from the illumination device according to image information; and
a projection device that projects an image formed by the spatial light modulation device.

16. A projector comprising:
the illumination device according to claim 8;
a spatial light modulation device that modulates light emitted from the illumination device according to image information; and
a projection device that projects an image formed by the spatial light modulation device.

17. A projector comprising:
a light emitting element that includes an active layer, a first clad layer and a second clad layer with the active layer interposed therebetween, and a first gain region and a second gain region generating light when a current flows through the active layer;
a control unit that operates the light emitting element so that light is alternately generated in the first gain region and the second gain region;
a first lens to which light emitted from a first light emitting portion of the first gain region and light emitted from a second light emitting portion of the second gain region are incident;
a spatial light modulation device that modulates light emitted from the first lens according to image information; and
a projection device that projects an image formed by the spatial light modulation device.
